(19) United States
(12) Patent Application Publication
(10) Pub. No.: US 2010/0138478 A1
(43) Pub. Date: Jun. 3, 2010

(54) METHOD OF USING INFORMATION SET IN VIDEO RESOURCE

(76) Inventor: Zhiping Meng, Luzhou Sichuan (CN)

Correspondence Address: DAVID AND RAYMOND PATENT FIRM, 108 N. YNEZ AVE., SUITE 128, MONTEREY PARK, CA, 91754, US

(21) Appl. No.: 12/451,374

(22) PCT Filed: May 8, 2008
(86) PCT No.: PCT/CN2008/070912

§ 371 Date: Nov. 7, 2009

(30) Foreign Application Priority Data
May 8, 2007 (CN) 200710097774.0

(51) Int. Cl. G06F 15/16; H04N 7/173

(52) U.S. Cl. 709/203; 709/231; 725/109

(57) ABSTRACT

A method uses information set in video resources, wherein video transmission is extended by introducing information sets into the client, server and extended server, which provides a good platform for video services based on various applications; all information sets include position set, operation set and function set. The position set accurately divides positions where new businesses and applications are generated, and makes various positions associated with specific objects, to set attribute information for various position objects. The introduction of various attribute information enriches the to applications of video. The invention introduces intra-frame and out-of-frame service mechanism for better management of the existing position set, operation set and function set. The invention changes the shortcomings of existing video technologies focusing on compression and quality and adapts to the video application and control, to provide a good technical platform and a reference plan of application mode for the future video application technologies.

### BACKGROUND OF THE PRESENT INVENTION

1. Field of Invention

The invention relates to the video information dealing technology, more particularly, the invention relates to the method to use information set in video resources.

2. Description of Related Arts

With the updated technology, one image is made up of many layers that each layer contains a series of MB (Macro Block). The MB arrangement can be sorted in the order of rester scan, or without the order of rester scan. The rester scan maps two-dimensional rectangular grating onto one dimensional grating whose entery starts at the first line of two-dimensional grating. Then, it scans the second line and third line until the last line orderly. The lines of the grating are scanned from left to right. Accordingly, FMO (Flexible Macroblock Ordering, also called layer groups technology) mode is one of the great features of H.264, suitable to the application of basic and expended grades of H.264.

Inter prediction mechanisms of image such as intra-prediction or motion vector prediction, permit only to use space-adjacent macroblocks or layers of the same layer group, with every layer independently decoded. Macroblocks from different layers can't be considered as the prediction reference to their respective layers. Therefore, the setting of layer won't cause error spread. With the help of macroblock allocating and mapping technology, FMO mode distributes every macroblock to the layers not following the scanning order. The modes for FMO dividing images are various, among which, checkerboard pattern and rectangle pattern are more important. Of cause, FMO mode can also partition the macroblock sequence of one frame, making the partitioned layers smaller then wireless network MTU (Maxim Transport Unit). The image data partitioned by FMO mode will be transferred separately. Although FMO can be considered as a single transferring or correcting unit, yet no mechanism can feel the operation of customers in this range (layer group).

With the updated technology, video or huge image information is an integrated whole. For video, it always follows the sequence of playing from the first frame to the last one. The player can flexibly achieve fast forward and fast backward function of video program by use of RTSP (Real-time Streaming Protocol). For image, it always searches the fixed coordinate of some position and then accurately ordinates the details of this position. As position information for either video or image is very limited (for example, it's very difficult to locate some specified macroblock in some zone of a certain frame), lots of applications can't be successfully carried out. Especially for video, the confirming of position resources is still a blank space.

However, for lack of relative information (like service information) except video coding, and moreover, as the video itself don't provide a method or means to skip or retrieve data, it's quite difficult to combine videos with services together and to realize timely interaction with clients. As a result, it's lack of an effective method for IPTV (Internet Protocol Television) system to realize interaction with clients, and hence fails to collect the clients' data.

As for the current dealing methods for video resources, they only simply promote video images to clients without efficient interaction. What's more, because the current video coding aims at compressing video and transferring high-qualified video and audio information by use of current network, the design object itself determines that it can't fulfill its interaction with clients. Among the current popular coding, H.264, MPEG 4, MPEG 2, AVS are relatively mature, which all aim at compressing and decompressing code. However, with the improving of network technology, the network bandwidth problems are gradually solved. Clients show more and more requirements to videos, not only for the quality of video, but also for more application and interaction.

### SUMMARY OF THE PRESENT INVENTION

The problem to be solved by the embodiment of the invention is to offer a method to use the information set in the video resource, so as to solve the insufficient information related to the vide resource of the existing technology and the inflexible service interaction between customers.

In order to achieve the above objective, the embodiment of this invention has offered a method to use the information set in the video resource, which includes the following steps.

The server adds information sets in video resources by video out-of-frame or intra-frame addition methods. The video out-of-frame addition methods include information description file, service frame and information communication. The video resources include: video files, video frames, video images and video streams. The information sets include: position set and/or operation set and/or function set.

The server sends the information set to the client or sets the information set at the client; wherein the servers include: video server and/or information set addition server.

Based on the position set information in the information set, the client confirms the activation position, uses the corresponding operation sets to operate and activate the corresponding functions of operation set and/or function set, and performs the corresponding functions. The operation set and/or function set are set at client and/or server.

The operation set and function set corresponding to the position set are set at client and/or are sent to the client by the server, wherein the position set and/or operation set and/or function set are not included into the information set sent to the client by the server, but are set at the client or extended server.

The position sets further include: coordinates of specific position inside video frames or images, or macro-block, intraframe stripe position information; or the specified zone inside video frame or images or specified zone position profile or stripe group position information; or the position identification of video frame in the whole frame sequence; or the program frame sequence group identification; or stream identification.

The function sets further include: recapturing the information for object at specific position, skipping to the specific position, sending information to the specified object position, opening or inserting objects at specified position, closing objects displaying the specified position and moving the objects at specified position. The specified positions include: the specific URL of the Internet, the address of a certain device in hardware devices, a certain storage position in storage devices, the specific positions of the display screen, browser and player window.

The operation sets further include: mouse operation, keyboard operation, information set position search during playing and operation in accordance with the preset procedure and information driving procedure operation.

The position set, operation set and function set can include the following proportion and combination:

1 position set element: multiple operation set elements: multiple function set elements.

Multiple position set elements: multiple operation set elements: multiple function set elements.

1 position set element: 1 operation set element: multiple function set elements.

Multiple position set elements: multiple operation set elements: 1 function set element.

1 position set element: multiple operation set elements: 1 function set element.

Multiple position set elements: 1 operation set element: multiple function set elements.

1 position set element: 1 operation set element: 1 function set element.

Multiple position set elements: 1 operation set element: 1 function set element.

The position set elements do not include attributes or include one or several attributes.

Each position in the position sets corresponds to 1 object:

The coordinate of specific position inside video frames or images, or the position information of intraframe macro-block and stripe—corresponds to 1 point object;

Or the specified zone or specified zone profile, intraframe stripe group positions or images—correspond to 1 block object in video resources, and the block is the sets of points or macro-blocks or stripes;

Or the position identification of video resources in the whole frame sequence-corresponds to 1 program object;

Or the identification of program frame sequence group—corresponds to 1 program object;

Or the stream identification—corresponds to 1 stream object;

The position objects include the attribute information of 1 or several objects, and the attribute information include: priority information, transparency information, encryption information, copyright information, client information, operation set under support, information sources and/or target information, addition time and/or effective time of position set and the attribute for introducing new objects from position set.

The priority information in the object attributes is used for the cooperated operation of different position sets: when flows with different priority are simultaneously played in the same player, the stream with the highest priority is played; when program frame sequence groups with different priority are simultaneously played in the same player, the program frame sequence group with the highest priority is played; when frames with different priority are simultaneously played in the same client, the frame with the highest priority is played; that is to say, when multiple information with different priority are located in the same position at the same position set, and these information are played in the same player, only the information with the highest priority can be played.

The transparency information in the object attributes is used for defining the transparency of objects corresponding to position set;

The encryption information in the object attributes is used for encrypting the objects corresponding to position set, including encryption modes and key information.

The copyright information in the object attributes is used for describing and protecting the copyright of the objects corresponding to position set, including the ownership information, authentication information and use information of copyright.

The client information in the object attributes is used for describing the client authority of the objects corresponding to position set and utilizing the client classification information, the client authority description includes: download authority and play authority; the utilization of client classification information includes: the classified control of the content itself.

The attributes for introducing new objects from position set in object attributes are used for identifying the attributes and functions of new objects introduced from position set and describing the movement conditions; the new objects include: video, flashes, pictures, images, sounds and word; The attributes for introducing new objects from position set include: the creation time of new object, the position parameter and movement status in position set, the duration and end time of the object, and the relation with position sets or surrounding objects.

The capturing methods of zone inside the frame of the position sets include:

Adopting the FMO mode of H.264, randomly assign macro-block to different slice groups by setting the mapping table of macro-block sequence, and take the slice group zone as the position to add information set; or

Adopting the VOL method of MPEG4, take the position of display zone of object stream corresponding to frames as the position to add information set; or

Adopting image recognition algorithm, object tracking algorithm and algorithm of extracting foreground objects from background, or respectively identifying the object zone between frames and then adopting the interpolation method to divide various zones in video frames; the above zones are positions for adding information sets.

A universal information set, including all of the position set, the operation set and the function set and the property of the object corresponding to the position set, is set at the client and/or server and/or extending server, while the information set corresponding to the video resources received at client is described as a subset of the universal information set.

The client will determine the activation position according to the position set information of the information set and shall use this position set to operate the corresponding operation set to activate the function set corresponding to the position set; the corresponding functions to be executed include:

At first, the client shall determine whether the position set information of information set is in the universal position set; if not, no operation shall be carried out or all operation is invalid; otherwise, acquire the current operation set and determine whether the operation of the corresponding operation set (the operation set should be included in the universal operation set) exists in the position set; if exists, execute the program instruction of function set corresponding to the position set and the operation set; otherwise, no program instruction of function set shall be executed.

The jump function is included in the function set; to be specifically, the jump function mainly includes: jump to another frame after the operation of one frame, jump from the display zone of one frame to the designated zone of another one, jump from the display zone of one frame to another frame and jump from one frame to the designated zone of another one.

The zoning of the zone in the video frame consists of the following two modes: object-based zoning or free zoning.

The invention also provides a system of using information set in the video resources, which includes the client and the server.

The server shall add information set in the video resources by video out-of-frame or intra-frame addition methods, and send this information set to the client. The video out-of-frame addition method consists of the description file mode of information set, service frame mode or message communication mode.

The client shall determine the activation position as per the position set information of the information set, and use this position set's corresponding operation set to activate the corresponding function set of the position set and/or operation set and execute the corresponding function. The operation set and/or function set shall be set at the client and/or the server.

The server includes:

Media import module is arranged for importing the media stream into the server.

Information adding module is arranged for creating information set file and/or adding the information set to media file.

Media storage module is arranged for storing the information set and/or media file.

Network module is arranged for sending information set and/or media stream from the server to the client.

The client includes:

Network module is arranged for acquiring information set and/or media stream from the server.

Information identity module is arranged for acquiring and identifying the content of information set, including position set, operation set and function set.

Operation sensing module is arranged for acquiring the executed operation in the operation set corresponding to the position set.

Function realization module is arranged for activating the corresponding function set of the position set and/or operation set and execute the corresponding function.

Media play module is arranged for playing the corresponding media information;

The corresponding function of information set is realized by the server coordinating with one or more clients, or is realized by the client coordinating with one or more servers.

The system also includes the extending server coordinating with the client to carry out the designated function:

The extending server includes:

Function realization module is arranged for coordinating with the client to carry out the designated function of the information set;

Network module is arranged for the information communication between the client and the extending server;

The corresponding function of information set is realized by the extending server coordinating with one or more clients, or is realized by the client coordinating with one or more extending servers.

At the system level, any two of the server, the client and the extending server can be merged, with their functions mutually independent, which can be realized by putting in one hardware or by putting in one software platform;

Position set, operation set and function set may show up in a given function form; for example, set the operation set at the client, or server or extending server, and the functions can be set to be realized at the client or extending sever with given program.

The invention also provides a method of adding service frame into the video resources, which includes the following steps.

The server create service frame in the video resources.

Add information set content into the service frame.

The server uses the service frame to load the information set and to send it to the client; each service frame is corresponding to the one or more video frames continuously or discretely organized.

The service frame has the basic frame structure and the information set are stored in the frame structure.

The information sets loaded by the service frame include: the position set, the operation set corresponding to the position set, and the function set corresponding to the position set and/or operation set.

Each position in the position set has a corresponding object, and each position object has one or more object properties. The object properties include: the priority information, the transparency information, the encrypted message, the copyright information, the client information, the supported operation set, the information source and/or target information, the adding time and/or the valid time of position set, the new object's property introduced from to the position set.

The service frame will be created at the same time of creating the video frame file, or be created after the creation of the video frame file;

The service frame and video frame can be transmitted in one transmission path or be transmitted individually in different path;

The service frame and video frame can be analyzed with one or several different grammatical structures;

The service frame and video frame can be stored in one file or respectively in different files;

The service frame can adopt the compressed or uncompressed method for transmission.

The invention also provides a method of adding frame sequence into the video resource, which includes the following steps.

Choose several adjacent or nonadjacent frames that have logical relation at the server and make these frames as an orderly set, viz. frame sequence group.

Make the start position and/or end position of frame sequence group as an element of the position set.

Add the position object property of the frame sequence group into the corresponding position set property.

The frame sequence group is corresponding to the logically continuous video clips and the position object property of the frame sequence group includes:

The priority information, the encrypted message, the copyright information, the client information, the supported operation set, the information source and/or target information, the adding time and/or the valid time of position set;

The encrypted message in the object properties is used for the encryption of the position set's corresponding object and it includes encrypted mode and key information.

The copyright information is used for the copyright introduction and protection of the position set's corresponding object, including the copyright ownership information, the copyright authentication information and the copyright application information.

The client information is used for introducing the client permission of the position set's corresponding object and applying client's classified information; the introduction of client permission includes the permission for downloading or playing; the application of the client's classified information include the classified control of content.

The invention also provides one method of adding zone object and its property into the video resources, which includes the following steps.

The server shall execute zoning in the video resources and the zoning mode includes: object-based zoning or free zoning.

Regarding the zone as the object, the server shall set the corresponding property information for each object and set the corresponding information set.

The object zoning includes: marking the object zone manually, tracking automatically the object position and marking the object's contour information; or marking manually each individual object zone at the apart number frame, simulate the motion curve by using the interpolation method, and marking the object's contour information.

The invention also provides a method of adding priority into the video resources, which includes the following steps.

The server shall add priority information into the property information of position set in the information set.

The client shall carry out the merge operation of different positions as per the priority: When the frames of different priority are played simultaneously at the same client, only the frame with the highest priority shall be played; or when the zones with different priority are displayed in one frame, only the zone with the highest priority shall be displayed.

The invention also provides a method of collecting user information through executing operation on the position set object in the video frame, which includes the following steps.

The client shall acquire the streaming media and the corresponding information set of the streaming media.

The client shall execute the operation set in the information set corresponding to media for receiving and send the information set content and client information to the extending server.

The extending server shall collect the client information from the client and the content information related to media; the client information includes: the client's network address, the client's ID and property.

The invention also provides one method of using information set in the video frame, which includes the following steps.

The server shall acquire the video frame required to be added to the information set.

Choose an intra-frame position to add the information set; the position to be chosen includes the head of video frame or its tail.

The invention also provides a method to add regional position profile into video resources, which includes the following steps.

Partition the mentioned regional position into squares of same size which can be calculated by pixel, including: 1×1, 2×2, 4×4, 8×8, 16×16, 32×32; In addition, the situations of every line crossing through the squares are marked separately by a number.

When the mentioned squares are crossed through by regional position profile, mark the two points of squares being entered and exited, and then connect the two points by line, which is considered as part of regional position profile.

When all the mentioned regional position profiles are marked by the line crossing through squares, find the situation of line crossing through squares which is most close to the exist number mark, and then mark it in accordance with the predefined number for square-penetrating situations.

The invention also provides a method to set zone or regional profile for video frame based on the current video structure, which includes the following steps.

During video coding, a new plane is added based on the exist three-dimensional video data, and then zone or regional profile can be set in this plane.

The server codes the new plane together with the current video data and then sent them to the client.

The mentioned method of setting zone in plane is: adopting zone code or geometry parameters.

The number of the mentioned plane is one or more.

The invention also provides one method to confirm position information in service layer and to control object, which includes the following steps.

Receive video information, and play it at ordinary video playing layer.

Superimpose service layer upon the ordinary video playing layer, confirm the position information of the service layer, and control the new media objects at the defined position within the mentioned service layer.

The positions of the mentioned new media objects are defined at the position set centralizing information, or at the fixed position chosen by mouse or keyboard at client side.

The mentioned method of operating new media objects includes local control and remote control. The former is to use keyboard or mouse to control the new media objects, while the later is to control the new media objects by the method of information set through server.

The mentioned method of controlling new media objects includes: creating new object, moving object, canceling object, and switching object.

The mentioned new media objects include: video, cartoon, image, sounds or words.

Compared with the present technology, the embodiment of this invention has the following advantages:

In the embodiment of this invention, concepts of the position set object and its attribute are introduced. More precise control can be taken to videos. Change the current situation of the present video technique of attaching importance to compression and belittling application, and afford the video technique application with a good implementation platform. This invention closely combines the application and the video itself and then cooperates with the operation set and the function set to complete the interactive function. In order to develop the function of position object better, this invention defines varieties of attributes for the position object. The introduction of these attributes can better develop the application of position object.

In the embodiment of this invention, the concepts of position set, operation set and function set, as well as the new communication transmission method are introduced in order to realize the interactive function with the users. It completes the interactive function with the users very well and is able to complete the acquisition and the analysis of the users' information. So it can realize the service personalization and promote the content to each user according to his demand. For example, promote the user with the advertisements of contents or commodities which he usually clicks. This can realize the reform of advertising technique

These and other objectives, features, and advantages of the present invention will become apparent from the following detailed description, the accompanying drawings, and the appended claims.

### BRIEF DESCRIPTION OF THE DRAWINGS

FIG. 1 is a flow chart of describing a kind of method for applying information set in video resources in this invention.

FIG. 2 is the schematic diagram in this invention of the interrelation among the position set, the operation set and the function set.

FIG. 3 is the flow chart in this invention of utilizing the position set, the operation set and the function set to conduct operation.

FIG. 4 is the schematic diagram in this invention of the position set including object division.

FIG. 5 is the structural chart in this invention of program frame sequence group with start code and end code.

FIG. 6 is the schematic diagram in this invention of skipping from one appointed zone to another appointed zone in one image.

FIG. 7 is the schematic diagram in this invention of the position set, the operation set and function set, which are corresponding to the three zones in one image.

FIG. 8 is the schematic diagram in this invention of implementing withdrawing operation in the successive frame.

FIG. 9 is the schematic diagram in this invention of one frame skipping to another frame after the corresponding operation is conducted;

FIG. 10 is the schematic diagram in this invention of the display zone in one frame skipping to the appointed zone in another frame;

FIG. 11 is the schematic diagram in this invention of the display zone in one frame skipping to another frame;

FIG. 12 is the schematic diagram in this invention of one frame skipping to the appointed zone of another frame;

FIG. 13 is the schematic diagram in this invention of using different digital sets to indicate one zone in the image;

FIG. 14 is the schematic diagram in this invention of adopting 16 splitting method to indicate the contour of an image;

FIG. 15 is the schematic diagram in this invention of 8*8 macro block disposal;

FIG. 16 is the schematic diagram in this invention of FIG. 13 after being disposed by the center;

FIG. 17 is the schematic diagram in this invention of using ellipse or rectangle to mark a contour;

FIG. 18 is a flow chart in this invention of the method to using information set in video resources;

FIG. 19 is the schematic diagram in this invention of the only confirmed position of each macro block in the image;

FIG. 20 is the schematic diagram in this invention of one kind of zone division;

FIG. 21 is the schematic diagram in this invention of one typical zone division of priority layer;

FIG. 22 is the system structural chart in this invention of one method to add information set into the video resources;

FIG. 23a and FIG. 23b are the system structural charts in this invention of another method to add information set into the video resources;

FIG. 24 is the schematic diagram in this invention of newly added service frame;

FIG. 25a and FIG. 25b is the schematic diagram in this invention of the service zone in the video frame.

FIG. 26 is the schematic diagram in this invention of the cooperation work of the service, the client and the extended server in the mode of message-driven;

FIG. 27 is the schematic diagram in this invention of completing the function by the cooperation work of the server, the client and the extended server in the mode of generating information set file;

FIG. 28 is the schematic diagram in this invention of adding 1 dimension or multi-dimensions on the basis of YUV 3-D video coding to divide the zone;

FIG. 29 is the structural schematic diagram in this invention of the service layer;

FIG. 30 is the diagram in this invention of the relation between the service layer and ordinary playing layer.

### DETAILED DESCRIPTION OF THE PREFERRED EMBODIMENT

The invention uses information set in the video resources, adopts the method of setting position set in the video resources for some information of television, movie or advertisement, associates the position set with the related operation set, and then associates the position set, the operation set and some specific function to realize a certain function.

The position set includes: the coordinate of a specific position in the video frame or in the image, or the position information of the intra-frame macro block or stripe or in the image; or the position information of the appointed zone, appointed zone contour or stripe in the video frame or in the image; or the position identification in the whole frame sequence; or the identification of program frame sequence group; or stream identification;

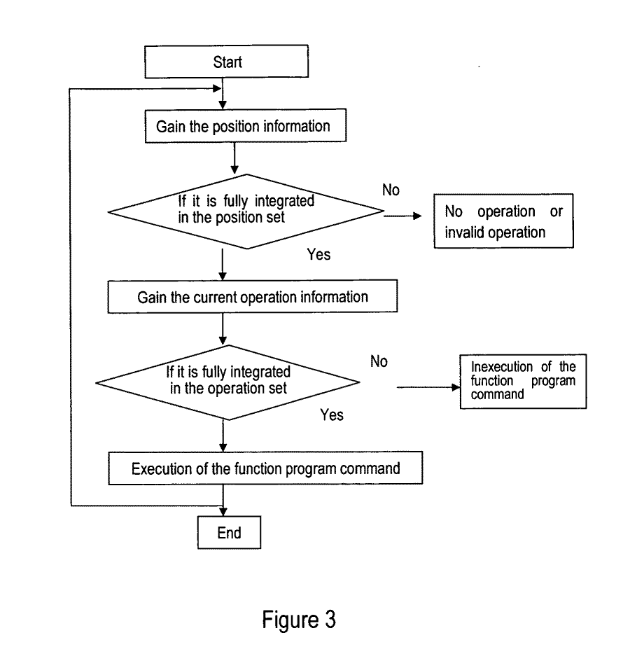

As FIG. 3 shows, the method to set position set is as followed:

The coordinate of the specific position in the video frame or image is (x, y). The position of intra-frame macro block can be identified by the number or the coordinate of intra-frame macro block. The stripe can be identified by stripe number. The stripe is very easy to be identified as an individual transmission structure. The intra-frame coordinate structure is a point object. The stripe or the macro block is a zone and a basic display unit; therefore in the embodiment of this invention it shall be disposed as a point object as well. During the transmission, it can be transmitted in the intra-frame service zone or by the mode of service frame.

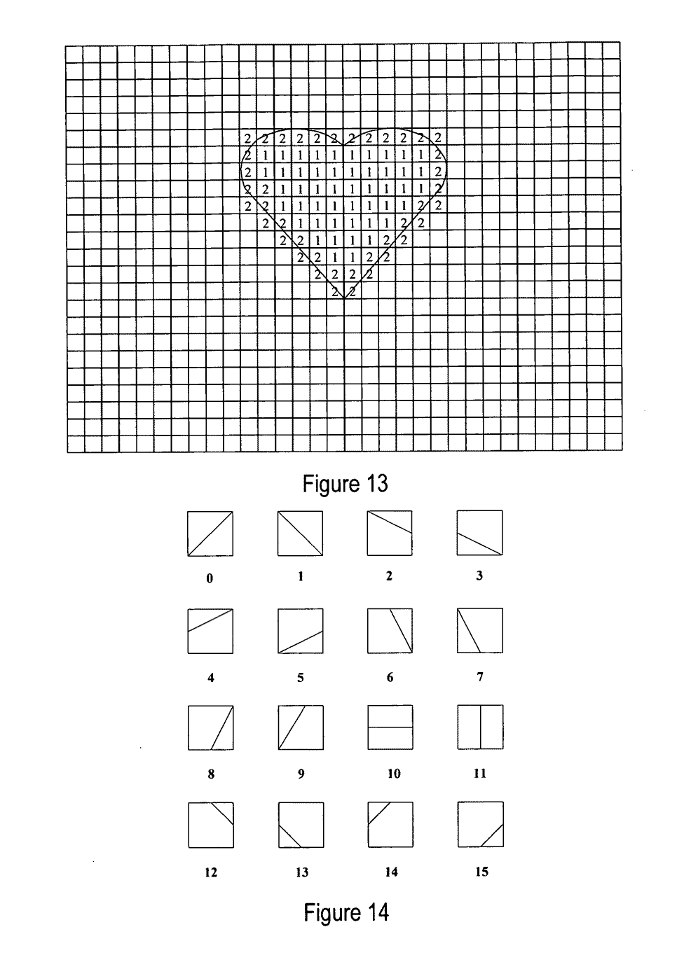

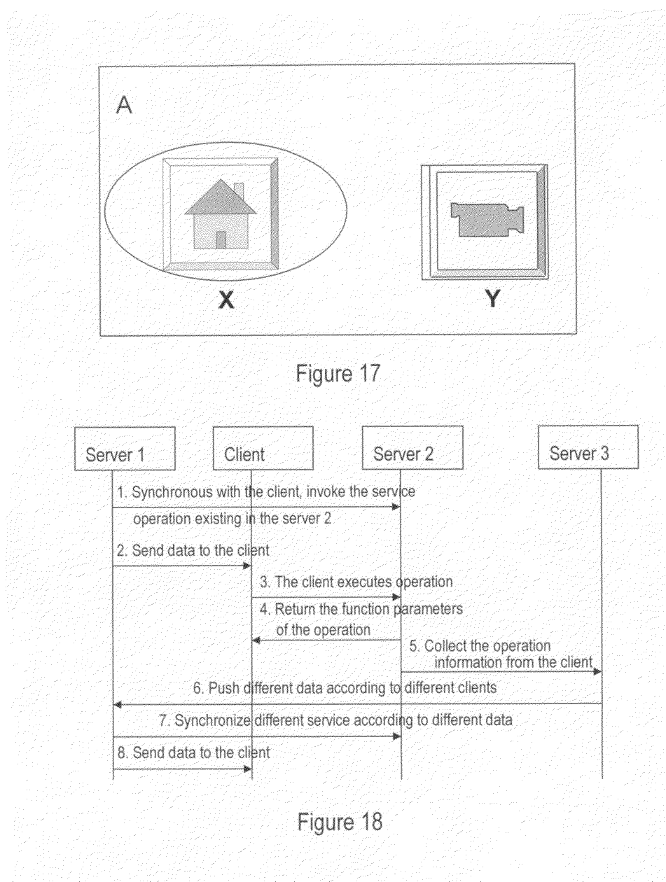

The stripe group, the appointed zone or the appointed zone contour in the video frame in the embodiment of this invention are considered as a zone object. The method of stripe group indication has been already matured and can be indicated by the identification of stripe group. The appointed zone object can be indicated by the method of borrowing stripe group and be indicated as zone number at last. When distinguish different zones or contours, the zone number of the embodiment of this invention can be adopted as FIGS. 13 and 17 indicate. When adopt the method, which is similar to stripe group, to indicate the zone, separate coding is required. Otherwise, separate coding will be unnecessary. One dimension or multi-dimensions can be added on the basis of present YUV 3-D video coding as FIG. 28 indicates. The method of service frame can be adopted to distinguish different zone position in service frame as well. When adopt the method mentioned above as adding the present dimensions of video, the added information can be put into the service zone in the video frame for code transmission or put into the service zone for code transmission. Certainly, the method of file or information controlling can be adopted to transmit the zone information.

The position identification of video frame in the whole frame sequence is the serial number of the frame. Every frame has a number or a start code/end code to indicate the position of the frame or the image in the whole frame sequence. This position information can be put into the service frame to conduct transmission. It will be convenient to control and add operation set and function in.

The position of program frame sequence group can be the same as the position of video frame. Adopt the serial number of a frame to identify or adopt the single structure as FIG. 5 indicates. The purpose is to distinguish each channel in the continuous process of video transmission. Artificial interruption is always required in channel distinguishing. Artificially set the start and end of the channel. As well, service control mode in or out of frame can be adopted.

The number setting of the video stream as 1, 2, 3 . . . can be adopted as the method of video stream identification. Or adopt the IP addresses from different places (including the original address or destination address, including broadcast address and non-broadcast address) to distinguish different streams; or adopt the single identification coding of each channel to conduct the identification. Still, the two kinds of control modes as intra-frame or out-of-frame can be adopted as the method of transmission.

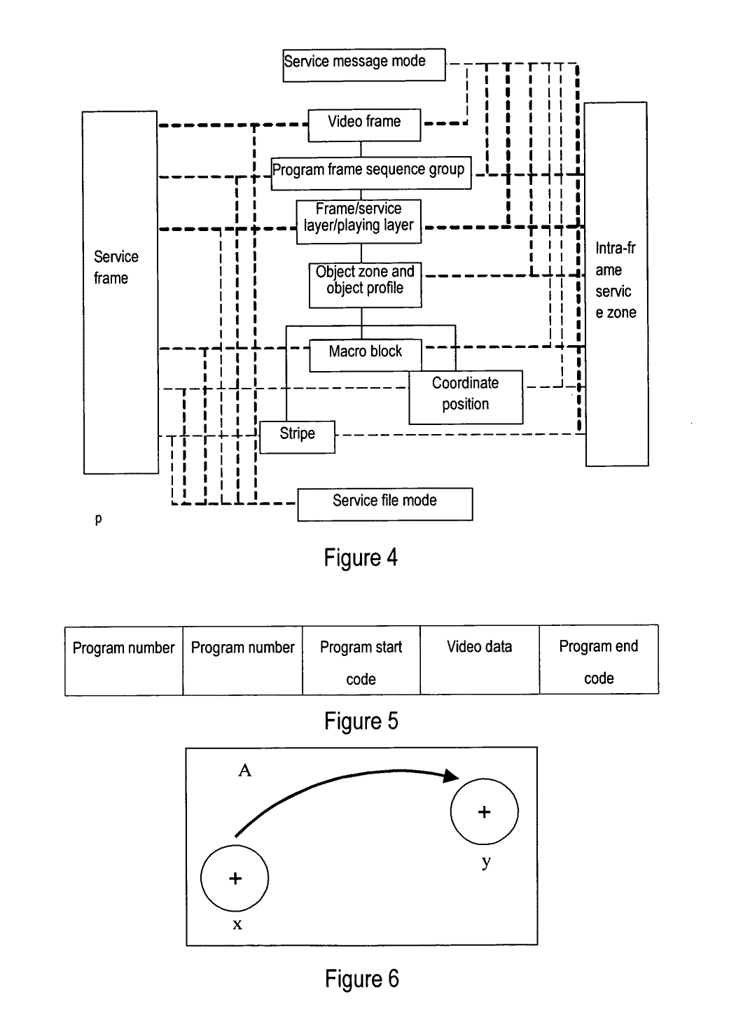

Attention shall be paid to that: because the position set has a certain belonging relation. For example, one coordinate or one macro block must be included in a zone; and this zone is included in a frame; a frame may be included in a section of program frame group; and this program frame group must belong to a specific stream. So if it is required to identify a more precise position, which is indicated as a lower position in FIG. 4, the attribute of the position in the higher layer will be needed. For example, to confirm a position of a zone, the indication mode as followed is usually adopted:

**Stream>**Program frame sequence group>**Frame or layer>**Zone, among which, “>” indicates the layer relation in the zone, this layer relation has also been indicated in FIG. 4.

Among which, the layers include the ordinary video playing layer and the service layer defined in this invention. The size of service layer is usually the same as the size of video playing layer. But the service layer is located above the video playing layer. In position set, the identification can also be precise to the certain zone, zone contour or specific coordinate position.

The information set, the operation set and the function set in this invention are abstract concept of set. It does not mean that the function name or unit of this kind really exist in actual application. All the method logic, belonging to this invention, belongs to the protective content of this invention.

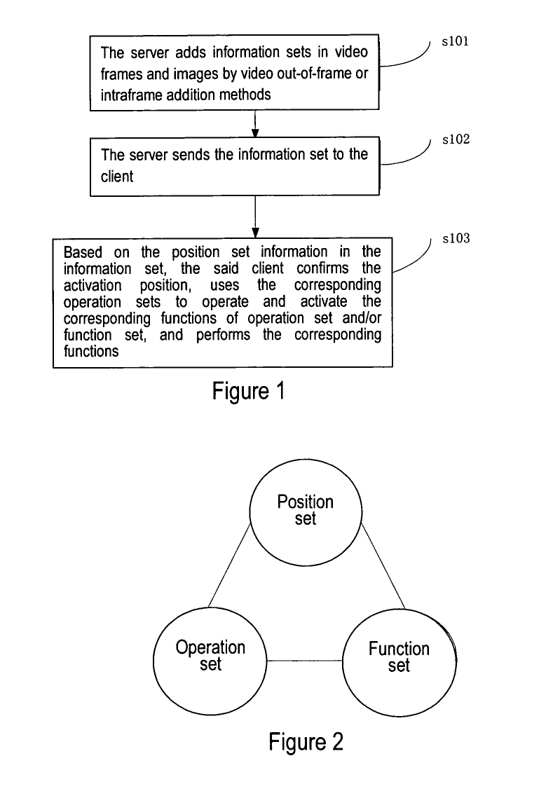

This invention provides a method of using information set in the video resources, which comprises the following steps as shown in the FIG. 1:

Step s101: the server manages the video resources by the video out-of-frame or intra-frame addition methods, and is also used as the carrier for transmitting the information set; the video out-of-frame addition method consists of the description file mode of information set, the service frame mode or the message communication mode, among which, the information set comprises position set, operation set and function set, and the position set further comprises: the specific position's coordinate in video frame or image or the spherical coordinate, such as the coordinate values of a certain point or pixel in the video frame, or the video macroblock in frame, or the position information of stripe; it also comprises: the position information of the designated zone or the contour of the designated zone in the video frame or image, the stripe group position information, the contour or position coordinate of the specific object in the video frame or image (Generally, the contour will correspond with certain position or object in the video resources, the coding method is adopted to distinguish the contour or position coordinate of the specific object in the video frame or image.), and the position or contour of different zones segmented in the video frame or image. The position identification of video resources in the complete frame sequence comprises the start code and the end code of video resources, referring to the position or serial number of the start or termination frame corresponding to a certain specific programme section in this video-broadcasting on demand; or it comprises the identification of programme frame sequence group for identifying a content relevant frame set, such as an episode or a video of a TV series; it also comprises the streaming identification.

In addition, the position set also comprises the property information of position that comprises the priority using for the merger operation of different positions: When the frames with different priorities are played simultaneously at the same client, only the frame with the highest priority shall be played; or when the zones with different priorities are displayed in one frame, only the zone with the highest priority shall be displayed.

Each position in the position set is corresponding to an object: the specific position coordinates in the video frame or image, or the position information of intra-frame macroblock or stripe—corresponding to a point object; the position of the designated zone or the contour of the designated zone in the video frame or image, or the stripe group—corresponding to a block object in the video frame and the block is the set of points, or macroblocks or stripes; the position identification of the video frame in the complete frame sequence—corresponding to a frame object; or the identification of programme frame sequence group—corresponding to a programme object; the stream identification—corresponding to a stream object. The position object comprises the property information of one or more objects, and the property information comprises: the priority information, the transparency information, the encrypted message, the copyright information, the client information, the supported operation set, the information source and/or target information, the adding time and/or the valid time of position set, etc.

The priority information in the object property is applied for the merger operation of different position sets: When the streams with different priorities are played simultaneously in the same player, only the stream with the highest priority shall be played; or when the programme frame sequence groups with different priorities are displayed in one player, only the programme frame sequence group with the highest priority shall be displayed; or when the frames with different priorities are played simultaneously at the same client, only the frame with the highest priority shall be played; or when the zones with different priorities are displayed in one frame, only the zone with the highest priority shall be displayed; namely, when several information with different priorities is located at the same position of the position set and is played in one player simultaneously, only the information with the highest priority will be played. In the object properties, the transparency information is used for the definition of transparency of the object corresponding to the position set; the encrypted message is used for the encryption of the object corresponding to the position set, including encrypted mode and key information; the copyright information is used for the copyright introduction and protection of the object corresponding to the position set, including the copyright ownership information, the copyright authentication information and the copyright application information; the client information is used for introducing the client permission of the object corresponding to the position set and applying client's segmented information; the introduction of client permission comprises the permission for downloading or playing; the application of the client's segmented information include the segmented control of content.

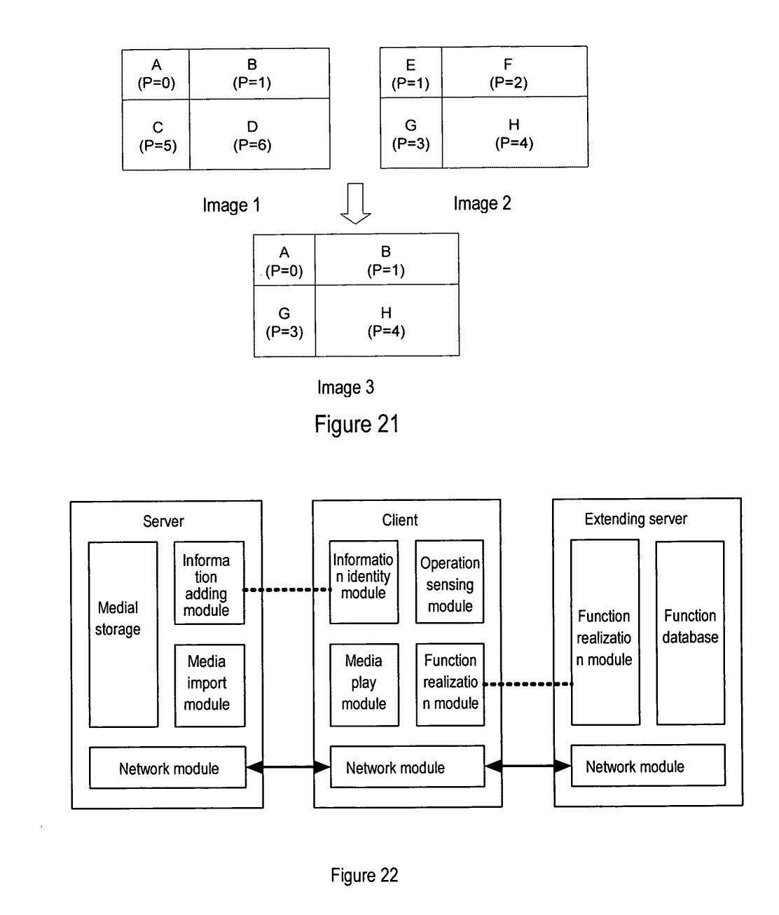

The function set further comprises: retrieving the object information of the contents of the specified position, jumping to the specifically designated position, sending messages to the designated object position, turning on or inserting the object for the designated position, turn off the real object for the designated position and moving the object for the designated position. Wherein, the designated position comprises: the specific URL in network, a certain address of the hardware device, a certain storage position for the storage device, the specific position of display screen, browser and broadcast window of player. In order to realize the priority function of the position set, the priority information should be set in the function set. As for zoning, set different priority in different zone, then overlaid-display several images in the same image, and define the priority of each part of the final image. As for the typical application of zoning as shown in FIG. 21, different priority can be set in different zone, using P representing the priority, if Level 0 is the highest priority, Level 1 is the second highest, which means the priority shall be decreased as the number becoming bigger. The priority can be set in different images and be overlaid-displayed in the same image; for example, the Image 1 and Image 2 shall be displayed as Image 3 after their priorities being overlaid; the highest priority of Zone A in Image 1 is 0, which is greater than that of the Zone E in Image 2, so the priority of the same position in Image 3 after being overlaid is displayed as the value of Zone A in the Image 1. In the similar way, the priority of Zone B in Image I is higher than the Zone F in Image 2, so the priority after being overlaid in Image 3 is the value of Zone B in Image 1. And also, we can fine out that the priorities of Zone G and H in Image 2 are greater than those of the same position of Zone C and D in Image 2; therefore, the Image 3 is finally synthesized.

The operation set is also called activation information set and it further comprises: mouse operation, keyboard operation, the operation of searching the position of information set when playing as per the pre-set procedures, and the information procedure-driven operation and so on.

The position set, operation set and function set can be matched by any proportional relation, including: one position set element: several operation set elements: several function set elements; several position set elements: several operation set elements: several function set elements; one position set element: one operation set elements several function set elements; several position set elements: several operation set elements: one function set element; one position set element: several operation set elements: one function set element; several position set elements: one operation set element: several function set elements; one position set element: one operation set element: one function set element; several position set elements: one operation set element: one function set element.

Set intra-frame zone of position set in a certain zone of video frame or image, and there are three methods:

The first one is to adopt FMO mode in H.264. Assign freely macroblock to different slice set by setting macroblock sequence mapping table (MBAmap) and set the slice set zone as the position for adding the information set. FMO mode may disrupt the sequence of the original macroblock, reduce the coding efficiency, and increase the time lapse, while the error resilience performance is enhanced. FMO mode has various kinds of modes for segmenting image, mainly including chessboard mode and rectangle mode. Certainly, the FMO mode can also segment the macroblock sequence in a frame and the size of the segmented slice is smaller than the MTU dimension of wireless network. Therefore, the slice set position can be used as the position for adding the information set, which means that match the identification of slice set with certain specific information.

The second method is to adopt the VOL method in MPEG4, viz. an individual foreground object stream. Set the object stream's corresponding display position in frame as the position for adding the information set.

The third method: Through using image recognition algorithm, object tracking algorithm, the algorithm obtained from the background by the foreground object, or identifying respectively the object zone manually in the adjacent number frame, and then through the interpolation method, segment different intra-frame zones and the zone is made as the position for adding the information set.

Before the added information comes into effect, firstly it should be positioned in the video resources, viz. there is position for it and it can be positioned, and then the operation set and function set can be extracted. Generally, there are two methods for dealing with the position set information: as for the information already existed in the video resources, such as the frame sequence number that is the only frame information for determining the position of frame, the position coordinate of image (pixel representation), it is only necessary to define the operation set and the function set; as for the information non-existed in the current video resources, such as the contour information of specific object in the video resources, the segmented zone information in the video resources and the information identifying a complete programme, all these information shall be defined in this invention and the position information shall be matched with the operation set and the function set.

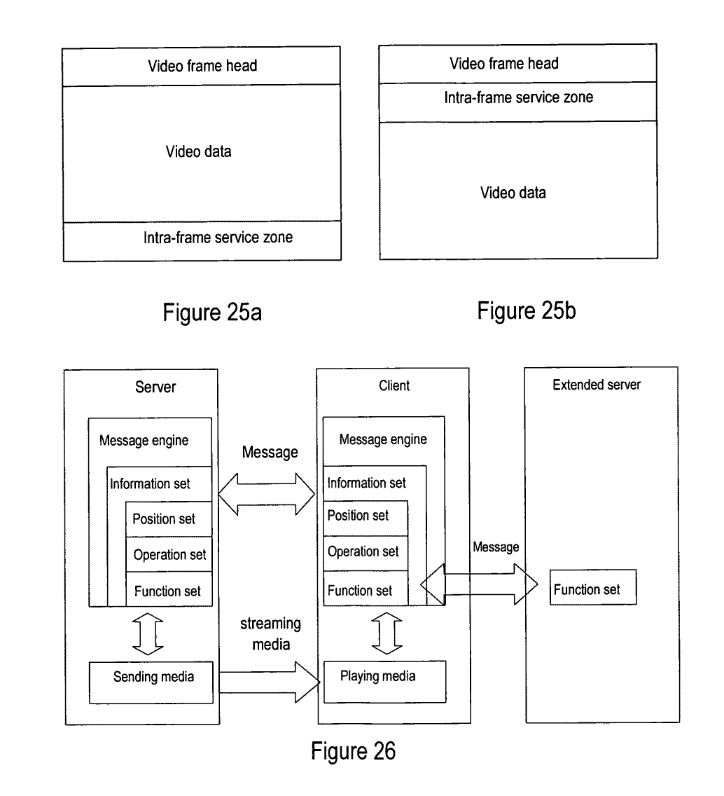

The video intra-frame service zone can be set in the existing video frame, which consists of the video frame head and the video frame data; while the video frame service zone can be set in the existing video frame tail, viz. on the back of the video intra-frame data, or set between the existing video frame head and the video data, as shown in FIGS. 25a and 25b.

Step s102: The server sends the information set to the client. The position set is usually defined in the video resources, and the operation set and function set are usually realized by the following two methods: The first method: send the subset information of operation set and/or function set to the client by server also and define the universal set of the operation set and/or function set at the client; the client receives the subset of operation set or function set as per the preset procedures, and execute certain function as per client's specific operation; during the transmission, the operation and function subset can be delivered as data information or control information; as for the existing transfer protocol such as RTP and RTCP, they always separate the audio or video from the control information, or transmit the video, audio and data as separate packages in TS structure; the content of operation subset and/or function subset can also be transmitted by a single file.

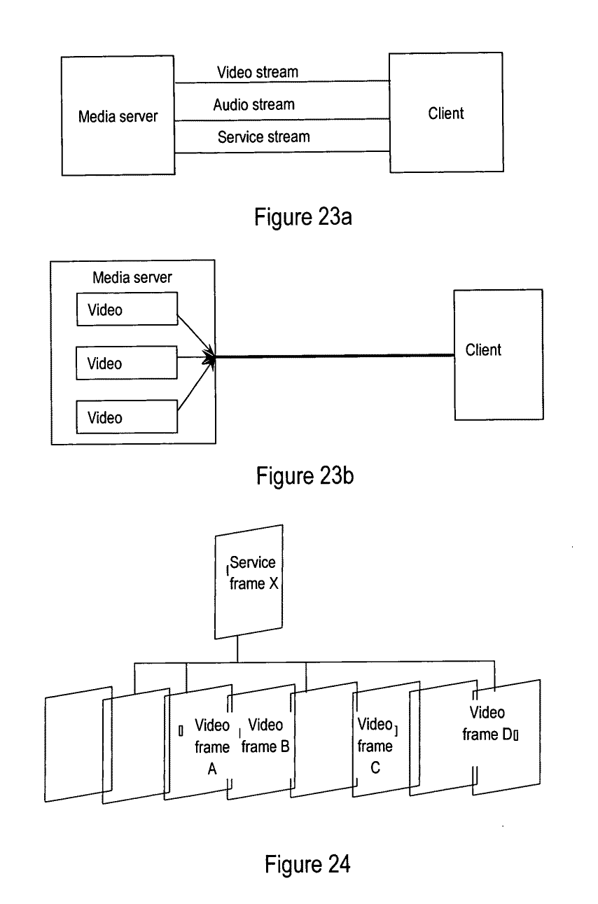

The second method: The server shall only transmit the position set and the operation set and function set shall only be defined at the client or server. The call of operation set and function set can be achieved by the remote procedure call (callback) method or through message to accomplish the preset function. As shown in FIGS. 23a and 23b, the video, audio and service data can be transmitted respectively by different port, or be transmitted in one port through packing the video, audio and service data in one structure united. After receiving the video content and information set, if the client edits the video content and add in new information set, and then send the video content to the server or extending server, the client serves as the server during this new interactive process. So actually this process is the C/S (client/server) mode, and they are the same essentially.

Actually, if only the client can obtain information set, it can achieve the function of embodiment of this invention. However, the places from which information is obtained aren't unique. It can be from the server of information set, as shown in FIG. 22, where server of information set and medium server are collectively referred to as server; or it can artificially set the content of information set at client, and then fulfill the designated function. Information set is always put together with medium server; however, it can be set at other servers different from medium server.

At Step s103, the client confirms the activated position based on the information of position set in information set, and operates and activates the position set by use of the operation set corresponding to this position set, and/or implements the corresponding functions by use of the function set corresponding to the operation set, among which the operation set and/or function set can be defined at the client and/or server. However, the operation set and function set corresponding to the position set can be preset at the client, or be sent from the server to the client; while this position set must be sent from the server to the client. The operation set and function set can be predefined at the client or the expanded server instead of being contained in the information set sent from the server to the client.

The client can define the universal set of information set, including all the position sets, operation sets and function sets, and thus it can determine whether the information sent from the server to the client is included in the universal information set; the server can define the entire information set, including all the position sets, operation sets and function sets, and thus it can deal with the original video and add information set to it.

Now detailed introduction is provided combined with specified embodiment as shown in FIG. 2, as the fact that position set, operation set and function set are integrated and cooperative. The position set guarantees that a certain position of the video resources can be uniquely determined and be activated for one or more service function by one or more fixed operations or automatic operations. The information of position set which is enclosed in video resources like bit stream, video frame, and etc., can be achieved by adding it to a code or in the manner of a single document, or can be obtained in the manner of message through connecting channel specially established for video users. Position set is an abstract concept which means that the position set doesn't necessarily correspond to a certain position in the observed video image. The position set corresponds to the operation set, while one operation of a certain position corresponds to one or more function sets. One kind of function will always carry out one kind of operation to one position, or will feedback the implementation results of function to some position, where these two positions aren't defined in the position set, since it's very difficult to determinedly define some position as the one where function is operated or returned, because of the infinite variety of functions. Almost all positions can be considered as the position where function is operated or returned. A universal set can be set for position set as well as operation set or function set. However, as the function range described by function set is far too wide, it's not necessary to set a universal set. The information of operation set can be achieved in the manner of users' receipt, or be specified in the client program. Every operation of the operation set corresponds to one or more function sets. The information of function set can be achieved by users and be specified in the client program, what's more, these functions should be specified at the corresponding server and be realized. Sometimes, the client can also work as a server to realize some functions, for example, skipping function, which means that users can skip to some specific URL by click some specific position of video resource. The above skipping function can be automatically realized as a subset of function set at the server.

The information in the information set of some video data or image corresponds to the information types of one or more information sets and the operations of one or more operation sets, and hence fulfills a certain or some specified functions of the function set. As shown in FIG. 3, the client firstly determines whether the information of position set in the information set is within the universal set of position set; if not, there is no operation or no valid operation; if any, the current operation set is achieved. And then the client will determine whether there are operations corresponding to the positions in the position set (the mentioned operation set should be within the universal operation set); if any, the program instructions of function set corresponding to the position set and operation set are executed; if not, the program instructions of function set aren't executed.

The concept of service frame is added to FIG. 3. The purpose of service frame is to carry service information, and try not to change the current frame structure. For the convenience of transmission, most of the current videos on the internet are compressed video information. In order to easily add specified services, the concept of service frame is introduced to the current video frames like frame I, frame B and frame P. each service frame corresponds to one or more continuous or separated frames. As shown in FIG. 24, service frame X corresponds to frames A, B, C, D.

One service frame consists of: the video frame corresponding to the service frame (here, the video frame means the compressed frame of transmitting video coding) and the message set corresponding to video frame including position set, function set and operation set. Service frame can be transmitted in the video stream shown in FIG. 23b, or in service stream shown in FIG. 23a. Service frame corresponds to one or more continuous or separate video frames. If one service frame corresponds to one service frame, it'll carry all the service information of video frame providing service, with all the information included in message set.

One important point of the invention is changing the existing video stream which possesses non-standard data structure into standard one. Its goal is easily identifying any position in this video stream, as shown in FIG. 4, that is marking out the accurate position information for the existing streams, such as the stream number, program frame sequence group position and number, frame position and number, object zone and regional profile position and number, and position of specific coordinate inside slice/macro-block/frame, and then organizing these information into a integrated position set.

For the frame position, the existing MPEG-2 system specification defines 3 data packages (PES, PS and TS) and 2 data streams (PS and TS). The single data stream multiplexed by PES-Packageized Elementary Stream with common time reference is called as PS-Program Stream. ES-Elementary Stream refers to the data stream only with 1 information source coder. Each ES is comprised of several videos (including I, P or B frames) or AU-Access Unit. Each AU includes the header and the coded data. After grouping the ES into PES, each PES package consists of 3 parts, i.e. package header, specific information for ES and the package data. PES package header is composed of 3 parts, i.e. start code prefix, data stream recognition and PES package length information. The start code prefix of package is comprised of 23 continuous “0” and “1”; it is an 8 bit integer, indicating the data stream recognition of useful information categories. Both of them combine 1 special package start code, which can be used for recognizing the characteristics and number of data stream (video, audio or others) that the data package belongs to. The combination of package header and specific information for ES forms 1 data head, including the fixed display time PTS and decoding time DTS of time information. The package of PES can be with random length, or may be with the length of the whole sequence. And this can be further compressed into PS package or TS package, so as to form program stream and transmission stream. This feature determines the exchangeability between program stream (PS) and transmission stream (TS). PS package is composed of package head, system head and PES package, in which PS package head is composed of start code of PS package, the basic part of SCR-System Clock Reference, the extended part of SCR and PS multiplex code rate. Therefore, the sequence number for each frame can be found in the structure of counter in TS. Or the position of GOP (group of pictures) can be found, and then the position of specific frame can be found through the sequence number of frame in GOP.

Meanwhile, the sequence number of specialized video frame in the whole video sequence can be customized, and the sequence number can be put into video stream to transfer to the server for recognition. The sequence number of video frame should be not less than 3 bytes, and if it is calculated by 30 frames per second, the total frames of video programs throughout one day can be completely represented by 3 bytes. This frame sequence number is usually located at the header of transmission unit. The above method refers to the mode of putting the internally attached identification of frame into existing TS, or RTP structure or the service frame defined by this invention.

The number of stream can be located at the existing TS or RTP transmission structures, such as inside the TS package head or extension digit, or located at the service frame defined by this invention.

The sequence group number and position definition of program frame group can be located at the existing TS or RTP transmission structures, such as inside the TS package head or extension digit, or located at the service frame defined by this invention. But it is important to note that the sequence group of program frame is different from the GOP (group of pictures) defined in existing technologies. GOP concept includes neither program concept nor the logical meaning concerned with pictures, but simply divides the picture sequence into different GOP units. However, the program frame sequence group in the invention is a group of logically related video frame, which is always a single program or a logically related video clip.

The number or sequence number of zone or slice or zone profile inside video frames or images can be located at TS or RTP transmission structures, such as the package head position, but it is recommended that the content or attribute of zone be located at the service frame define by the invention. Alternatively, information of zones inside all video frames and images can be located at the service frame. For the coordinate, slice and macro-block inside video, please use the similar method. It is noted that positions of slice, slice group and macro-block are explicitly specified by the existing technologies; however, other positions are peculiar for the innovation of this invention.

Based on the above, the method using package head or intra-frame space for load-bearing in RTP or TS refers to the intra-frame service method of the invention, but the method using service frame or file belongs to out-of-frame service mode.

The program frame sequence group in video stream can be divided into specific frames which include slice group, slice, macro-block and specific point coordinate. The scope of position set identification is actually an object concept; for example, the program frame sequence group corresponds to a logically related video program or video clip object, and this object is embodied between start code and end code of program frame sequence group and includes one number of the program frame sequence group and attribute position corresponding to some attributes of an episode of this program. Similarly, the video frame corresponds to 1 image object, and the same as a plan, each video frame has start code and end code for frames, and its own attributes. The intraframe slice group, zone and zone profile are equivalent to the zone object within an image, having their numbers or/and attributes, and the scope is within this zone or slice group; with the scope within slice, macro-block or some specific coordinate, the coordinates within the frame of slice, macro-block and set series correspond 1 point object; see

FIG. 4 for details. Video stream number, program frame sequence group, zone and zone profile are new positions introduced by the invention, and please see FIG. 5 for their structures; series of frames are divided into frame groups, like some episode in TV play series, the frame groups usually possess internal relevance, and define the start code and end code of one program to identify an episode of the program. FIG. 5 identifies the start code, end code, program number and program attribute, so it is just an abstract method. The existing TS or RTP methods can bear these by putting them into the existing package head, i.e., adopting the intra-frame method referred by this invention.

As shown in FIG. 4, if the method of service frame is adopted, the controllable positions include video stream position, position of program frame sequence group, video frame position, and positions of object zone, zone profile, slice, space block and coordinate. Except the video stream, the intra-frame service area may control the information of other position sets. It is necessarily noted that the concept of service frame in FIG. 4 is an abstract one, which is set to control 1 or several continuous or discrete frame(s). The service frame is so called for the purpose of distinguishing from other video frames. The invention does not discuss what frame structure, frame length, and bearer protocol that this service frame will adopt. This invention only specifies the contents of the intra-frame information set. The size of service frames is unfixed, and they can be the same or different from each other. The concept of intra-frame service zone is a service concept that corresponds to the existing transmission packing method and frame format. The method for information addition through the packing and transmission process of video frames (TS stream or RTP) or the existing frame format belongs to intra-frame service zone mode. The service file method in FIG. 4 refers to the identification of the position information by using files, in addition, and these files may include other information sets. For service file method, such a file must be created and the information sets will be stored into the file. However, the message mode is mainly applicable to the method that needs real-time message exchange between server and client, among which the information sets (including position set, operation set and function set) are changed into several messages for the transmission between the server and client.

In this invention, the media stream can be managed by adding information sets into video resources, and it generally includes out-of-frame and intra-frame managements. Out-of-frame managements include service file mode and direct transmission mode; among which, the former uses position set, operation set and function set, but the later one uses control data (e.g. service frame, control stream and control data). Intra-frame managements refer to the position set addition into the existing frame structure, and operation set and/or function set also can be included. For instance, there are pre-reserved video extension start code or reserved code in the existing coding structure, and these pre-served codes can be considered as the start code or end code of information sets to add contents.

For example, in AVS code, the start code is a group of specific bit string. In the bit stream in conformity with the requirements of GB/T 20090.2, except the start code consisting of code prefix and value, these bit strings should not appear under any circumstance. The prefix of start code is bit string ‘0000 0000 0000 0000 0000 0001’, all bytes of start code should be aligned, the start code value is a 8 bit integer to represent the type of start code, and please see table 1 for details.

TABLE I
Value of Start Code

| | Value of Start Code |
|---|---|
| Type of Start Code | (Hexadecimal Number) |
| Stripe start code (slice_start_code) | 00~AF |
| Video sequence start code | B0 |
| (video_sequence_start_code) | |
| Video sequence end code | B1 |
| (video_sequence_end_code) | |
| User data start code (user_data_start_code) | B2 |
| Image I start code (i_picture_start_code) | B3 |
| Reservation | B4 |
| Video extension start code | B5 |
| (extension_start_code) | |
| Image PB start code (pb_picture_start_code) | B6 |
| Video edit code (video_edit_code) | B7 |
| Reservation | B8 |
| System start code | B9~FF |

When obtaining special value, part of the syntactic element can get the bit string same as the prefix of start code, which is known as the fake start code. In the table, all the reservation code B8, the video extension start code and the system start code B9˜FF can be used as the start code or end code of information set. In all, during the definition of a kind of video code, the similar start code or some temporarily unused code position can be reserved to be defined as the start position or end position of information set in the video frame. After having the aforesaid start code of information set, the content of information set can be added between the start code and end code (if existed), different information content can be distinguished by different start code identification, and the information content can define more specific information content by different level after the aforesaid start code. For example, the start code B8 indicates the start of the information set, the C9 after that indicates the position set, then D9 indicates the zone position in the position set, E9 indicates the property of zone position is priority, thus the definition of the position and its property can be realized precisely.

If the programme frame sequence group needs to be realized, the above-mentioned intra-frame control method can be adopted for adding the information set; for example, B10 indicates the information set, C10 indicates the following is the start code of one programme sequence group, after D10, the property, classification and encrypted information shall be defined, thus we can know clearly some of the content's property when decoding, so as to better control the play of programme. For example, if the programme is unsuitable for children, the programme grade shall be indicated in the property, so when playing, we can choose the proper programme for the right object; we can also add encrypted or authentication information in the property in order to identify if the programme is legal; the DRM verification content can also be added. All the above-mentioned methods belong to the method of loading information set by intra-frame service zone mode.

The object zone is a specific zone in this invention, which is corresponding to a specific object in the image; as shown in FIG. 17, a object zone may be marked by a ellipse or rectangle and it is usually a closed zone; if the object moves to the video boundary, the left and right, and the upper and bottom image boundary may form a closed zone, in which the same data set shall be usually used for identification, for example, use 1 identifying the object in the zone, and 0 is for the object out of the zone. The object zone can also be identified by a coordinate, using transverse and vertical coordinates for identification in the image, in addition, a specific macroblock or a pixel point in the macroblock can also be used.

The schematic diagram of jump to another designated zone from one designated zone in an image is shown in FIG. 6, to be specifically, it means jump to y zone from the x zone in Image A, in which, the display position is A: x, and the corresponding operation is “Jump to” with the jump position being A: y.

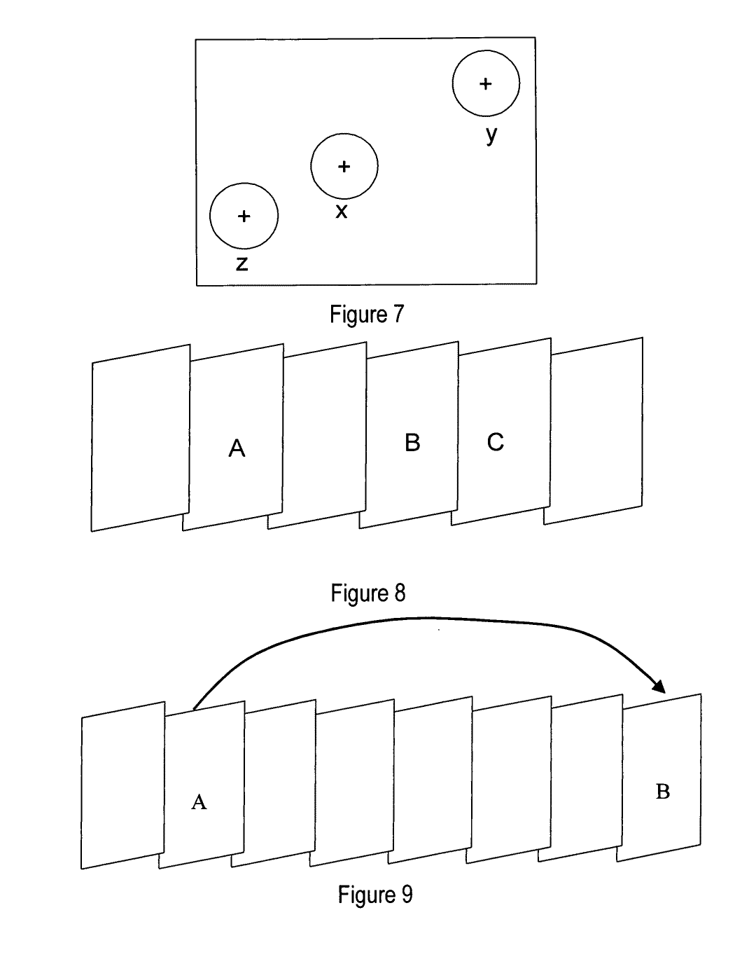

As shown in FIG. 7, x, y and z represent three zones in the figure: The corresponding operation set of x is mouse operation, the corresponding function set is to retrieve the information of a certain position, and the position of the information to be retrieved is “http://network address”; the corresponding operation set of y is keyboard operation, the corresponding function set is to retrieve the information of a certain position, and the position of the information to be retrieved is “hardware address (such as the address in hardware)”; the corresponding operation set of z is other keypress operation, the corresponding function set is to retrieve the information of a certain position, and the position of the information to be retrieved is “memory address”.

As shown in FIG. 8, in some continuous frames use the frame start code or end code to drive some operation, for example, when reading the start code of C frame, it shall automatically goes to the memory to retrieve some information; when in A frame, by executing the mouse operation, it is possible to retrieve the information corresponding to HTTP protocol in network; the information of local hardware, such as content in hardware, can be retrieved by operating the keyboard in A frame.

As shown in FIG. 9, after the corresponding jump operation is carried out, the A frame jumps to B frame.

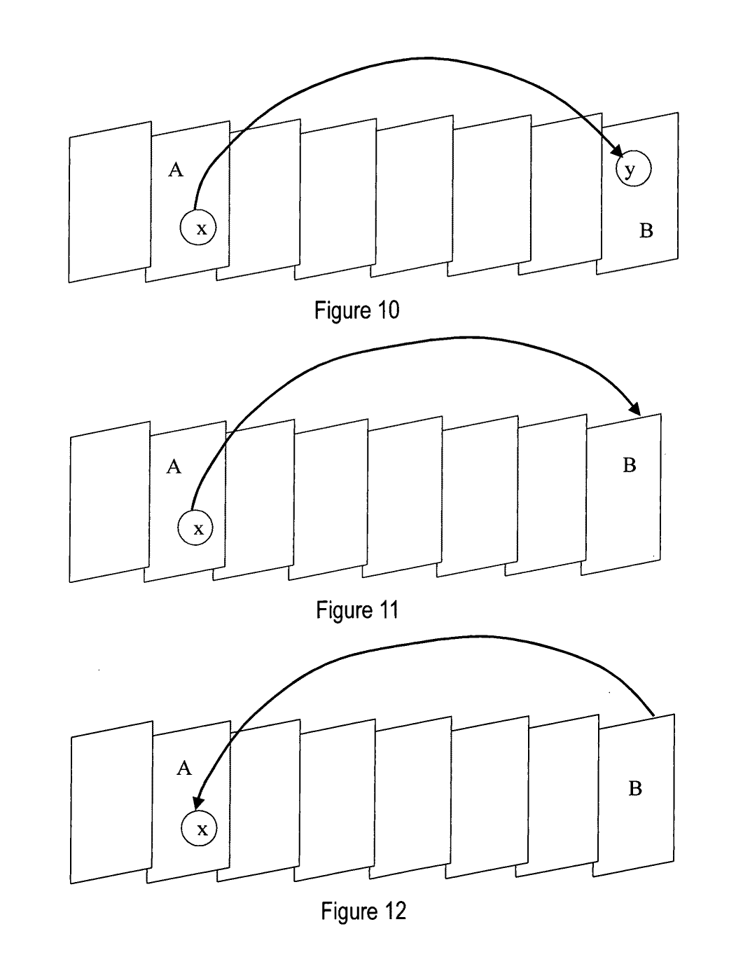

As shown in FIG. 10, after the corresponding jump operation is carried out, x zone in A frame jumps to y zone in B frame.

As shown in FIG. 11, after the corresponding jump operation is carried out, x zone in A frame jumps to the position in B frame.

As shown in FIG. 12, after the corresponding jump operation is carried out, B frame jumps to x zone in A frame.

As shown in FIG. 13, it indicates the method of using different digital set to represent the zone in an image; use “2” to represent the macroblock on the edge of the heart-shape image and “1” for the macroblock inside the heart-shape image.

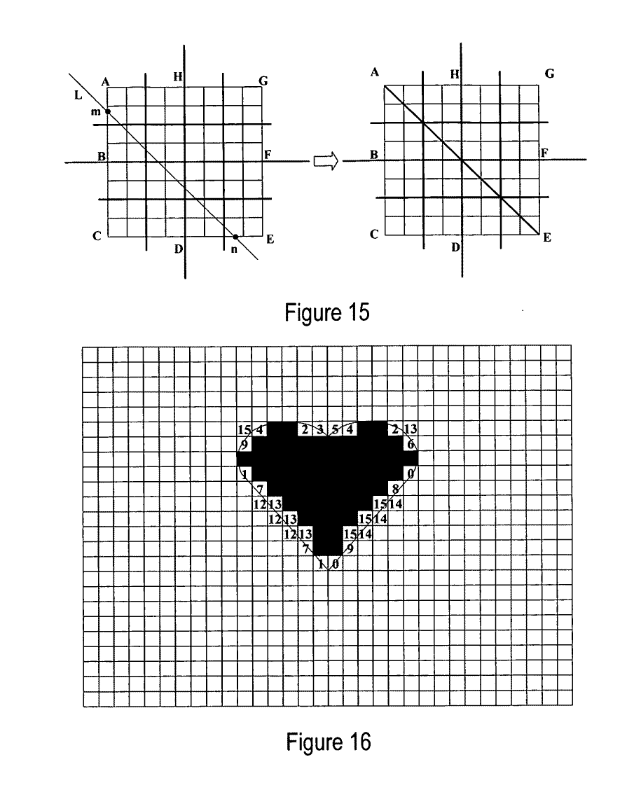

As shown in FIG. 14, the 16-segmentation method is adopted to more precisely represent the image contour. As shown in FIG. 15, given a straight line L passes through a macroblock with the dimension of 8×8, and it meets the AC side of the macroblock at m and CE side at n, judge whether m is more closely to A or B. Assuming that A, B is positive upwards and they are greater than 0, viz.

$$m > \frac{A + B}{2} or m \geq \frac{A + B}{2} ;$$

if the above inequation is satisfied, move m point to the position overlaid by A point, if not satisfied, move m point to B position; treat n point in the similar way, so the right image in FIG. 15 can be obtained; compared with the code in FIG. 14, the code in FIG. 15 can be determined as “2”. In the similar way, the heart-shape image in FIG. 13 can be treated and changed to that of FIG. 16, thus, the contour information can be well marked.

FIG. 17 is the schematic diagram of contour marked by ellipse or rectangle. Three parameters are required for being marked by ellipse, viz. centre coordinate, long axis value and short axis value of ellipse; as for rectangle, three parameters are also required, viz. centre coordinate, long side and short side values of the rectangle. When the long axis and short axis of the ellipse are equal, it becomes a circle; when the long side and short side of the rectangle are equal, it becomes a square.

As per different realization of function, this invention mode may consist of the client, Server 1, Server 2 and Server 3. Server 1 provides media data service and it shall tell the client the position information, the corresponding operation and the function after operation. Server 2 is the function server, and the function set is usually realized by Server 2, or by the client itself, or accomplished by the coordination between the client and the function server; if the function requires to be accomplished by Server 2, or by the coordination between the client and Server 2, the relevant function should be informed to Server 2 through Server 1, so the Server 2 can help the client to realize the specific function in the function set. Server 3 is the statistical analysis server, which is used for the analysis and statistics of the user's action at client, for example, what kinds of information content the user clicks on; thus, through the analysis, we can customize the personalized services for the specific user at client, and inform the individual needs of the user to Server 1 through Server 3 so as to ensure the data pushed to the user is more attractive and service-efficient.

Wherein, the specific realization process is shown in FIG. 18, including:

1. Server 1 and the client synchronously call the existing service operation in Server 2;

2. Server 1 sends data to the client;

3. The client sends the operation-performing request to Server 2;

4. Server 2 returns the function parameter of operation to the client;

5. Server 2 collects the operation information of the client from Server 3;

6. Server 3 pushes different data for different client;

7. Server 1 performs different service as per different data synchronously with Server 2;

8. Server 1 sends data to the client.

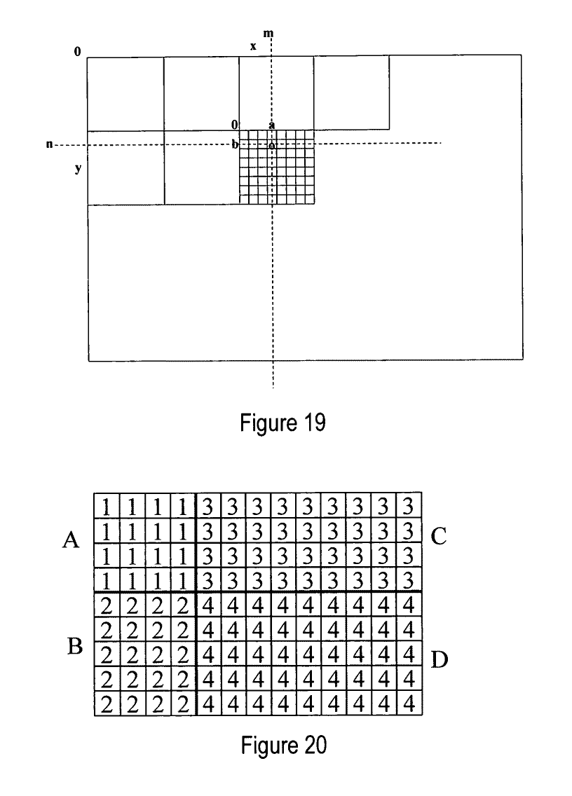

In this invention, as the type of macroblock can be defined through its number or its position, and through that the dimension of the macroblock can be determined, the position of each macroblock can determine its only position in the image. As shown in FIG. 19, as the horizontal and vertical dimensions of the image have been defined in the sequence head, the position of a certain pixel point can be precisely defined; take brightness as example, if the macroblock dimension is 8×8, and its position is (x, y), the position of o point in the macroblock is (a, b), each specific pixel position in the video can be defined in the similar way. Certainly, for the horizontal and vertical dimension of the image are known, the horizontal coordinate m and the vertical coordinate n can also be adopted to identify the specific position of a pixel. The value of m and n can be given, or can be obtained through calculation: assuming if x, y, a, b, m, n are counted from 1, then:

m=8×x+a

n=8×y+b

The method of intra-frame zoning comprises object-based zoning and free zoning, among which, the object-based zoning further has the following two methods: the first one: mark manually the object zone, track automatically the object position and identify the contour information of the object; the second method: mark respectively the object zone manually in the adjacent number frame, and then simulate the motion trail of the object by using the interpolation method, and finally identify the contour information of the object. Precise marking method can be adopted for identifying the contour, as shown in FIGS. 13 and 16, while using the graph to mark the rough contour of the object can also be used, as shown in FIG. 17. As for the free zoning, the screen is always segmented to several blocks as per actual requirement and each block shall not be overlaid by its surrounding blocks, as shown in FIG. 20.

This invention also provides a system of adding information set in the video resources, as shown in FIG. 22, which comprises the client and the server. The server shall add the information set by the video out-of-frame addition method or the video intra-frame addition method, and transmit the bitstream carrying the information set to the client; the video out-of-frame addition method consists of the description file mode of information set, the service frame mode or the message communication mode; the client shall determine the activation position as per the position information in the information set, and shall use the operation set corresponding to the position set to operate, activate the function set corresponding to the position set, and execute the corresponding functions.

Wherein, the server specifically comprises: the media import module, the information adding module for creating information set file and/or adding the information set to media file, the media storage module for storing the information set and/or media file, and the network module for sending information set and/or media file from the server to the client.

The client specifically comprises: the network module for acquiring information set and/or media file from the server, the information identification module for acquiring and identifying the content of information set, including position set, operation set and function set, the operation sensing module for acquiring the executed operation in the operation set corresponding to the position set, the function realization module for activating the corresponding function set of the position set and/or operation set and execute the corresponding function, and the media play module for playing the corresponding media files. Generally, the corresponding function of information set can be realized by the server coordinating with one or more clients, or be realized by the client coordinating with one or more servers.

Of course, in order to fulfill the needs of updating or extending system, extended servers can be added, and hence the client can coordinate with them to carry out the designed function. Extended servers include: function realization module which is used to realize module coordination with the client function and to carry out the corresponding functions of the information set; and interne module which is used to realize communication between the client and the extended server. Extended server can cooperate with one or more clients and realize the functions corresponding to the information set; or client can cooperate with one or more extended servers and realize the functions corresponding to the information set. At the system level, server, client and extended server can pair off, that is, they can be functionally independent; or they can be carried out together in the same hardware or the same software platform. As for actual application, position set, operation set and function set maybe in the form of a specific function, for example, the operation set is provided at the client or server or extended server; at the same time, the function set can also be carried out at the client or extended server by specified program.

It's worth noticing that, the client and the server are just separated in terms of concept, and that they can exist in the same hardware and/or software situation. For example, when users are adding new objects at the client by themselves, the client implements the function of the server and needs information sets including position set, operation set and function set as well. It's just that these parts can be integrated into the program language at the client, or that some of the parts can be integrated into the program language at the client or into documents of individual client. Both transmission and reading of information set can be fulfilled cooperatively with hardware and software at the client. The main purpose of this method is to enable the users to freely edit current video programs or documents which can be uploaded or downloaded, that is, users can edit video or video documents by the use of current position set.

As shown in FIG. 22, medium stream is led in the medium server through medium leading-in module, and then be added into information sets (position set, operation set and function set) through information adding module, among which, the information adding of position set is a must, while that of operation set or function set can be an option depending on the application requirements. Media added into information sets through the information adding module are sent to the client by internet, and then the client identifies the information sets added through the medium server by information identifying module, extracts all the information from information sets and waits for users' operation. The achievement of operation set and/or function set can be preset at the client by program, or be fulfilled at the medium server through the internet.

If the user implements the predefined operations in the operation set, the corresponding function module at the client is activated and then realizes the predefined function with the cooperation of extended server. At extended server, optional function realizing module can cooperate with client function module, probably in C/S mode or equivalent service mode. It would be possible that the client function module could independently carry out some functions without the help of function modules at extended servers. Extended servers are set for some specified services at the client, optional equipments to the whole system.

A universal information set can be set at the client, and hence, information set and its corresponding video resource obtained from the client can be determined in accordance with the universal information set. In fact, the information set obtained from the client and corresponding to video resources can be considered as one subset of the universal information set, which can determine whether the content of the mentioned information subset is reasonable or is within the definition range. At the same time, the mentioned universal information set can be defined at the server or extended server.

As shown in FIG. 22, the server consists of two functions as video server and information set server. The former provides video resources to the client, and then the client will play them through medium playing module; while the later provides information set to the client, and then the client can realize some special functions based on the information set obtained. During actual application, video server and information set server can be separated in different equipments or systems, providing services to the client. As for FIG. 22, the first thing a client needs to know is the information set carrying mode. Is it intra-frame mode or extra-frame mode? Then it needs to analyze the information set, providing the information set has been achieved already, and to extract the position set as its activated position. Finally, it'll realize specified functions in accordance with the corresponding operation set and function set.

As shown in FIG. 26, it's a schematic diagram as well as a system structure diagram of cooperation among server, client and extended server in message-driven mode. Server and client make real-time communication through message engine. Information set is included in the message engine, and at the same time includes position set, operation set and functions set. In such mode, streaming media and messages can be sent from the server to the client through the same transmitting channel or through different transmitting channels. Considering the real-time property, the server can add information set content in real time, and the client can also sense the added information set in real time. If the server can add advertisements to some designed position set of the sent medium in real time, the client can detect the possible operation set when it's playing the medium. If the client senses the added advertisement, and if the corresponding operation in the operation set is to automatically play the advertisement, the client will realize the function of automatically playing the advertisement inserted at the server.

Under some situations such as the client can't fulfill some complex function individually, it needs to cooperate with extended server to carry out the functions. The methods for client and extended server to communicate are several, like message, direct data exchanging (including data sending and receiving), remote program invoking, and etc. in message-driven mode, the message engine must contains the universal message set, i.e. all the definition of position set, operation set and function set.

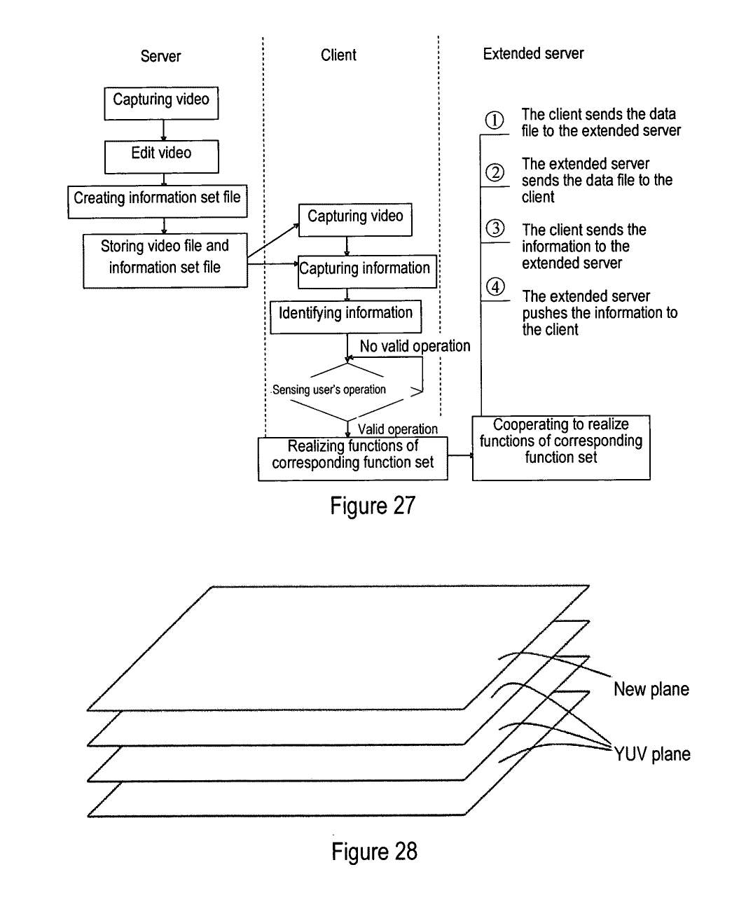

As FIG. 27 indicates, the schematic diagram of completing function by the cooperation of the server, the client and the extended server in the mode of generating information set file is also the system structural chart of the server, the client and the extended server in the mode of message-driven. Firstly, use the server to acquire the video information, and then according to the demands, adopt the special edit tool or edit module to generate information set file. After that, send the video information and information set file to the client. The sending methods can be: sending the information set file before the video information, or sending the video information first, or the two can be sent at the same time. When the client receives the information set file, it will use the information set identification module or the identification tool to identify the information set content. And then the client senses the operation conducted by the user at the position set. The operation will be effective operation if it is included in the received information set. Then the corresponding function set of the operation set and position set will be implemented. If the executive operation is not included in the operation set of the information acquisition, it would be considered as invalid operation. When execute the client function, the cooperation of extended server is usually required to complete the function in the information set or the function saved in the client or the extended server.

The methods of interacting between the extended server and the client are message mode, digital interacting mode and the mode of remote procedure call, etc. When sending the data, XML mode or text or binary data, etc. can be adopted.

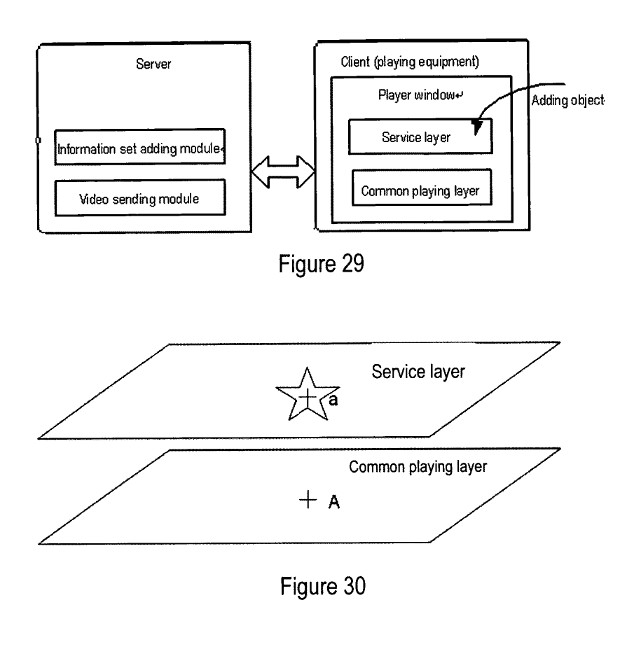

As FIG. 29 indicates, the client includes the play equipment with play window. The play window supports the ordinary play layer and the service layer when playing the video media. Use the ordinary play layer to play the video content received by the server. Use the service layer to insert new objects, which include videos, animations, pictures, vocals or literature, etc. The control of the service layer is made by the information set. The service layer port is used to send the video media information and the information set to the client. The server and the client here include all the modules indicated in FIG. 22. The service layer is usually a transparent layer, which is located above the present video play layer, and it is able to be inserted with media information freely.

The relation between the ordinary play layer and the service layer is indicated as FIG. 30. The service layer is an individual layer generated by the client and above the ordinary play layer. This layer is featured by being able to be inserted new media objects, the mentioned new media objects include: videos, animations, pictures, audios or texts, etc. This layer can appear or be created after the existence of the new media object, or it exists in the client always. In this layer, all the contents are transparent excepting for the inserted object. This can make the users directly see the contents in the ordinary play layer through this layer and integrate the two layers into one by visual. As FIG. 30 indicates, the surface around the new object “pentagram” in the service layer is head surface. In this way, when the user see this frame, he will see the pentagram pattern above the present play layer and the image of play layer out of the pentagram area. There will be coordinate A, which represents the position of the pentagram, in the play layer. When being defined, this position can be the position of center or upper left, upper right, down left and down right of the pentagram. It can also be a specific top point or center position of some certain geometric figure of the inserted object. For example, when a circle can encase the pentagram, the position of the pentagram can be defined as the center position of the circle. In this way, the position of the inserted object can be uniquely determined. And a coordinate corresponding to this position can surely be found in the ordinary play layer. However, the position set in the information set is defined according to the varieties of positions and the corresponding objects in the video stream. It is obvious that the service layer exists in the client but not in this video stream structure. But the unique and secured position of the ordinary play layer can be found in this stream structure. Therefore, the same position mapping of the object coordinate or position zone in the service layer can be found in the ordinary play layer. As FIG. 30 indicates, the position mapping of the position coordinate a corresponding to the pentagram in the service layer is A. In this way, the certain position in the ordinary play layer and the certain object in the service layer can be associated. If A is associated with the pentagram, the new object will be associated to the position set, which is corresponding to the information set. If A is associated to the pentagram, then the coordinate A in this invention is equal to an intra-frame image or a point object. Therefore, the position set in the video can indicate an object corresponding to itself as a point, a frame, or a zone, a frame, a frame set and a stream, etc. in the image. The new object in the service layer, which is corresponding to the position, can be indicated as well. So that, the method in this invention of carrying information set in or out of frame can be adopted to conduct control or related operation to this new object. If the new object of pentagram at A position is inserted to a position in the service layer, A and a will share a one-to-one correspondence. Master one and you'll master the other. Usually it indicates one position in different layers, which are indicated as the ordinary player layer and the service layer here. The method mentioned above is to control or operate the object in the service layer by the position of the ordinary play layer. The method of adding service layer positions in the position set can also be adopted to control or operate the object in the service layer.

There are two control methods to the objects in the service layer; one is to control the object in the service layer through the client software by the mouse, the keyboard or the remote control. For example, control the movement of the object in the service layer by defining the keys of UP, DOWN, LEFT and RIGHT in the keyboard, or use the mouse to point the aim coordinate; the other method is to control the object in the service layer by information set, this method requires the client to acquire the information set, and then control the object movement in the service layer according to the position set, the operation set and function set in the information set. For example, the position set is a certain coordinate in the service layer, this coordinate is corresponding to an object in the service layer, the operation is automatic, and the function is to move this object to the left by 10 pixels. Here the mouse or keyboard can be put into the operation set, which means the position set is the position of object in the service layer, the operation set is the left key of the mouse or the keys of UP, DOWN, LEFT and RIGHT in the keyboard, the function is to move to the position clicked by the left key of the mouse or the movement position of the keys in the keyboard. When create or delete the object, the two methods mentioned above can be adopted as well. For example, when create a new object in a specific service layer, the position set is the one of the position, which is selected by the mouse, or the position set in the information set. The operation is automatic. The function is to abstract a certain file from the URL or a specific file position and then play it in the service layer. The object can conduct some transform operations as largenning, lessening, or other distortion, etc. by the operation of the mouse or the keyboard or the function control in the information set.

The functions completed by the cooperation of the extended server and the client at the same time usually include the followed aspects:

The extended server sends data files to the client:

The typical applications are:

The extended server sends the data files to the client. This information includes videos, images, flashes, audios, texts, and it will be played at the client. The position of playing can be the player of the client, the explorer of the client or other playing software of the client, which support the mentioned media files. When playing, adopt the methods of stopping the present video image before the media information acquired from the extended server is inserted; or inserting the media information acquired from the extended server without stopping the present video image.

The client sends the data files to the extended server:

The typical applications are:

The client sends the media files as videos and audios, etc. to the extended server. If the corresponding function of the information set acquired at the client is to turn on the local equipments of camera or recorder, etc, these equipments are actually also described as an address and equipment ID. At this moment, the video-audio files recorded by the camera or the recorder will be created locally. And then these files will be sent to the extended server. The uploading command can be included in the function corresponding to the information set, which is to send the message. The uploading can be done manually as well.

The client sends messages to the extended server

The typical application is as follows: the extended server should count or analyze the service condition of the client and collect the information from the client. If the information set is corresponding to the function of playing advertisement at the client, the information of the client at each click will be transmitted to the extended server in order to count the clicking rate of the advertisement; thus the advertising can be analyzed in real time or not to achieve more accurate advertising in future.

The extended server pushes information to the client.

The typical applications are as follows:

(1) The extended server pushes information to the client and saves these pieces of information. Or the extended server converts the information into corresponding media object to be played on the player, browser or software terminal of the client; taking the online game for instance, the control over the client object is practiced through the message interaction between the extended server and the client; and the operating information of the client is transmitted to the extended server; if the client receives the control data about the client object A, the A is moved from position X to position Y in the video. In such a process, the information set generally contains the position X of A in the position set, the control ID of A belongs to the attribute of the object at the position A, and the function is to move the object A from the position X to Y. The function contains various contents, such as the mode of motion, y positional information and time of motion and the like. In addition, the information set should be established at a certain coordinate in a certain frame.

Although some mentioned above can only be accomplished through the interaction between the client and the extended server, the particular emphasis is laid on a certain respect. The following typical applications are all accomplished through the interaction between the client and the extended server, including three ones:

(1) Add digital right management function and encryption function: the available popular digital right management system DRM comprises the following four items: first, right description, generally, it is the data coexisting with the memory; the stated contents can be used, copied, saved and distributed in terms of how, when, where and by who; second, access and copy control, generally, the control is called technical protection measure (TPM), namely the right management is carried out through technical means to prevent the contents from being obtained and copied by the unauthorized user; third, confirmation and trace, the technical means (digital watermarking or fingerprint identification) is employed to confirm the origin of the content; fourth, charging and payment subsystem.

DRM may protect the contents such that the contents could not be used at the absence of proper right. The right is provided through content license that not only contains the information for unlocking the contents under protection but also appoints how, when and by who the contents are used. The content license required by the client can be issued through the extended server. The DRM information can be included in the intra-frame service area, service frame or service file of the invention, or issued from the server in the form of message; the DRM and the content protection system are both based on cryptographic algorithm and protocol, which comprise symmetric block encryption (AES, 3DES), asymmetric public key encryption (RSA, elliptical curve), safe Hash algorithm (SHA-1, -256), private key exchange (Diffie Hellman), authentication and digital certificate (X.509).

The content under encryption, encryption method and key of the contents can also be included in the intra-frame service area, service frame or service file of the invention, or the encrypted information is transferred in the form of message.

(2) Add new object in position set and control the new object: the entry new object comprises video object, animation, sound, picture and word and the like. A new object layer is created above the existing video play layer; and the control power of the layer is delivered over to the intra-frame service and out-of-frame service modes. Taking the picture for instance, the user adds in a GIF picture at a certain position at the client; the position is defined by the position set in the information set. If the GIF picture should be moved from the position A to B, the initial position, the attribute, the mode of motion and the destination etc. of GIF are added in the information set; and the control is bilateral, namely it can be transmitted to the client from the server or transmitted to the server from the client. Of course, the client, as a matter of fact, serves as the server when transmitting the information to the server in the invention, while the server is equivalent to the position of the client; therefore, they are interchangeable in concept. The technology at the new video layer can be brought into effect through the technology of the existing DirectShow based on DirectX or the dual display chip technology of Intel. When the server controls the service layer on the video layer of the client, the transmitted positional object in the information set is the GIF object; and the attribute carries with the information about the initial position, the attribute, the mode of motion and the destination. It is noteworthy that the extension implementation techniques on the service layer and the video-encoding digit are different; the service layer is positioned on the conventional video play layer and should be supported by the hardware and software of the client; the service layer is an abstract conception such that the server or client can conveniently insert new video object in the video. The new object is inserted through two of the following methods: first, the video object is added at the server, and the transmission can be carried out through the transmission channel the same as or different from that of the video; second, the position of the GIF at the client is confirmed through the saving function in the information set; then the GIF object is inserted in the service layer at the client through the functions of the function set in the information set; third, the GIF object is automatically added in the service layer at the client by the user; now, the client and the server are of the same equipment or software and hardware environment.

(3) The URL of a website is retrieved from the extended server and the service of the URL is played: if the URL of a website is added in the information set, the position set, the operation set and the function set are extracted from the information set when the video is played at the client. In this example, the position set can be the position of a specific frame; the corresponding operation set is extracted automatically, and the corresponding function set is employed to open the website information specified by the URL. Then the contents of the URL address are retrieved from the website, such as a WWW web page or a picture, and then played.

Some simple functions can be carried out at the client without independent extended server:

The typical applications are as follows:

Jump function, the jumping is carried out through the position set in the information set; when the position set is entirely in the video, the data needs not to be retrieved from the extended server; if the jump position is in the extended server or in a certain media file of the extended server, the data needs to be retrieved from the extended server. For example, a certain regional position is associated with the forward jump function in the video; when the position is clicked, the URL may automatically jump to the appointed position and play the content at the jumped position; thus the specified time shifting function can be realized, such as jumping to the video program 5 minutes ago.

Recording function, the function can be included in the right information to be managed with DRM; the position set in the information set is corresponding to the frame sequence group; the user attribute in the properties is downloadable, the function set is to be downloaded, and the operation set is to be clicked. If the specified position in the position set is clicked by the user at the client now, the video can be downloaded at the time when the video program is played. In this way, the recording function of the video is performed.

Priority function, if the position set in the information set corresponding to the first video frame is a specified region, the priority is the top priority; at this time, if there is the position set in the information set corresponding to the second video frame in the same specified region, the two frames are played in the same window, and the priority of the region corresponding to the second video frame is lower, only the region in the first frame with the highest priority is played. The other intra-frame regions are processed in accordance with the same principle, so the combined play of multiple paths of video streams can be achieved.

Transparency function, the function can also process the problem of combination of multiple paths of videos. If two frames need to be played in the same window, it can be firstly judged which one comes before the other one in terms of the priority; then the transparency is determined in compliance with the transparency attribute, wherein the transparency is generally 0 to 100.

The invention further provides a method for adding service frame in the video steam, consisting of the following steps:

A service frame is newly created at the server in the video resource; the service frame is created during the creation of the video file or after the generation of the video file; the service frame and the video frame are transmitted in the same transmission channel or in different ones, analyzed with the same grammatical structure or different ones and saved in the same file or different ones, respectively; the service frame can be transmitted through compression mode or non-compression mode. The service frame is provided with a basic frame structure; and the information set is packaged in the frame structure. The information set carried by the service frame includes the position set, the operation set corresponding to the position set and the function set corresponding to the position set and the operation set; the object properties of the position set further include the corresponding priority of each video frame, the priority of each region in frame, the position information of the region in frame and the motion information of the region in frame.

The contents of the information set are added in the service frame.

The server carries the information set with the service frame and transmits it to the client, wherein each service frame is corresponding to continuous or discrete one or more video frames.

The invention further offers a method for adding frame sequence group in the video resource, consisting of the following steps:

The server manually selects more adjacent or non-adjacent frames with logic relationship and arranges these frames in an ordered collection as a frame sequence group.

The starting and/or ending position(s) of the frame sequence group are/is used as an element in the position set.

The attribute of the positional object in the frame sequence group is also added in the attributes of the corresponding position set.

The frame sequence group is corresponding to the logically continuous video clips; and the properties of the positional object of the frame sequence group include priority information, encryption information, right information, customer information, supported operation set, origin and/or target information of the information, position set add time and/or valid time; the encryption information, including encryption mode and key information, in the object properties is employed to encrypt the object corresponding to the position set; the right information, including the ownership information, authentication information of right and service information of the right, in the object properties is utilized to describe and protect the right of the object corresponding to the to position set; the customer information in the object properties is employed to describe the right of the customer of the object corresponding to the position set and classify the information in terms of the customers; the customer right description comprises (this part can be included in the DRM of the right information to be managed) download right and play right; the classification of the information in terms of the customers comprises the classification control over the content.

The position set in the invention may come across the problem how to distinguish different regional objects; and an effective solution is available as shown in FIG. 28. The existing video frame is generally in three-dimensional structure; and the three dimensions include brightness and chrominance, such as YUV. Similarly, the RGB is also in three-dimensional structure. The invention increases one dimension based on the existing three-dimensional structure for distinguishing the different regions; the dimension is expressed through the method as shown in FIGS. 13-17 in detail. The increase of the dimension can excellently express the position and profile of the region. Also, the parameters such as priority and transparency can be set in the dimension. The carrying mode of the dimension can be the one of the intra-frame service region of the invention. The encoding mode and compression method can be the same as or different from the existing ones.

New video objects can be introduced into this dimension, for example, a monochrome binary image. If the binary images of every frame are connected together, it can form a binary image animation at video playing layer. With the same method, it can develop colorful animation based on the current video YUV. If three-dimensions or multi-dimensions are superimposed to YUV three-dimension, it can realize the superimposition of videos during transmission. Besides, the positions of superior and inferior videos can be realized by means of priority, that is, the superior ones are put at the upper layer, overlaying the videos with inferior priority. In addition, the transparency of the upper layer videos can be used to control the visibility of lower videos. The above methods can be used in one code frame for coding, with the current compression method or coding scheme. During coding, methods similar to the current coding scheme, i.e. motion prediction, DCT, quantization, and entropy coding can be adopted for newly-added dimensional data (the decoding methods are reversed: anti-entropy coding, anti-quantization, IDCT, and motion compensation), which can also be replaced by other methods. Or it can adopt no compression technology.

This invention also gives a method to add regional objects and their object properties to video resources, including the following steps:

The server divides zones in video resources with methods like zoning by object or free zoning. The former includes: 1. to manually indicate object zone, automatically trace the position of the object, and then identify the profile information of the object; 2. to manually indicate object zone separately in several adjacent frames, imitate the motion trace of the object by means of interpolation, and then identify the profile information of the object.

The server considers zones as objects, and sets corresponding property information for each object as well as corresponding information set.

This invention also gives a method to add priority level to video resources, including the following steps:

The server adds priority information to the property information of position set in information set;

The client undertakes merging operation of different positions in accordance with priority level: if frames of different priorities are played at the same client, only the frame with top priority is played; or if zones of different priorities are shown in the same frame, the zone with top priority is displayed.

This invention also gives a method to collect users' information by operating the objects of position set of video frames, including the following steps:

The clients obtain streaming media and their corresponding information set;

The client implements the operation set of the information set corresponding to the received media, and sends the information set content and users' information to the extended servers;

The extended sever collects users' information from the client and information related to media;

Users' information includes: user's interne address, user's ID and user's property.

This invention also gives a method to use information set in a video frame, including the following steps:

The server obtains the video frame which needs to add information set;

Choose an intra-frame position and add information set in it;

Position choosing includes in the head part of end part of video frames.

This invention also gives a method to add regional position profile to video resources, including the following steps:

Partition the mentioned regional position into squares of same size which can be calculated by pixel, including: 1×1, 2×2, 4×4, 8×8, 16×16, 32×32; In addition, the situations of every line crossing through the squares are marked separately by a number;

When squares are crossed through by regional position profile, mark the two points of squares being entered and exited, and then connect the two points by line, which is considered as part of regional position profile;

When all the regional position profiles are marked by the line crossing through squares, find the situation of line crossing through squares which is most close to the exist number mark, and then mark it in accordance with the predefined number for square-penetrating situations.

The technologies described by embodiment of this invention can be implemented by hardware or software or by both. If it's implemented by software, this technology can directly refer to computer-readable media containing program coding which can be implemented in the equipment coding video sequence, under which condition, computer-readable media consists of RAM (Random Access Memory), SDRAM (Synchronous Dynamic RAM), ROM (Read Only Memory), NVRAM (non-volatile RAM), EEPROM (Electrically-Erasable Programmable Read-Only Memory), FLASH, and etc.

Program coding can be stored in memory in the form of computer-readable instruction, under which situation, one or more processors can be used to implement the instructions stored in the memory, and then carry out one or more residual coding technologies. For some situations, processors can use a DSP (Digital Signal Processing) which speeds up the coding process by using various hardware elements; while for other situations, coding equipments can be used as one or more microprocessors, or one or more ASICs (Application-specific Integrated Circuit) or FPGA (Field Programmable Gate Array), or some other equivalent integrated or discrete logic circuits or hardware or software.

The above public information is only several specified embodiments of this invention; however, this invention isn't limited to this. Any changes that can be thought of by any technicians in this field should be within the protecting range of this invention.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

1-25. (canceled)

26. A method using information set in video resources comprising at least one of video files, video frames, video images and video streams, wherein the method comprises the steps of:
(a) adding information sets in video resources via a server by one of video out-of-frame method and an intra-frame addition method, wherein said information sets comprises at least one of position set, operation set, and function set, wherein said video out-of-frame addition methods comprises information description file, service frame and information communication; and
(b) obtaining said information set to a client by sending said information set to said client or setting said information set at said client via said server, wherein said server comprises at least one of video server and information set addition server;
wherein, based on said position set information in said information set, said client confirms the activation position, uses said corresponding operation sets to operate and activate corresponding functions of at least one of said operation set and said function set, and performs said corresponding functions, wherein at least one of said operation set and said function set is set at one of said client and said server, wherein said server and client are set in at least one of software environment and hardware environment.

27. The method, as recited in claim 26, wherein said operation set and function set corresponding to said position set are obtained by said client by setting at said client or by sending to said client by said server; wherein at least one of said position set, said operation set, and said function set is excluded into said information set sent to said client by said server, and is set at said client or extended server.

28. The method, as recited in claim 26, wherein said position set is selected from the group consisting of:
one of coordinates of specific position inside video frames/images, macro-block, and intraframe stripe position information;
one of specified zone inside video frames/images, specified zone position profile, and stripe group position information;
said position identification of video frame in the whole frame sequence and said position of corresponding service layer of video frame;
the program frame sequence group identification; and
stream identification;
wherein said function sets further comprises recapturing the information for object at specific position, skipping to said specific position, sending information to the specified object position, opening or inserting objects at specified position, closing objects displaying said specified position and moving said objects at specified position;
wherein said specified positions comprises the specific URL of the Internet, the address of a certain device in hardware devices, a certain storage position in storage devices, the specific positions of the display screen, browser and player window;
wherein said operation sets further comprises mouse operation, keyboard operation, information set position search during playing and operation in accordance with the preset procedure and information driving procedure operation;
wherein said position set, operation set and function set comprises one or more of proportions and combinations of:
1 position set element: multiple operation set elements: multiple function set elements;
Multiple position set elements: multiple operation set elements: multiple function set elements;
1 position set element: 1 operation set element: multiple function set elements;
Multiple position set elements: multiple operation set elements: 1 function set element;
1 position set element: multiple operation set elements: 1 function set element;
Multiple position set elements: 1 operation set element: multiple function set elements;
1 position set element: 1 operation set element: 1 function set element;
Multiple position set elements: 1 operation set element: 1 function set element;
wherein said position set elements is capable of including one or several attributes.

29. The method, as recited in claim 28, wherein each position in said position sets corresponds to 1 object which is selected from the group consisting of:
the coordinate of specific position inside video frames/images;
said position information of intraframe macro-block and stripe—corresponds to 1 point object;
one of the specified zone, specified zone profile, intraframe stripe group positions, and images thereof—correspond to 1 block object in video resources, wherein said block is the sets of one of points, macro-blocks, and stripes;
said position identification of video resources in the whole frame sequence, the corresponding service layer of video frame—correspond to 1 frame object;
the identification of program frame sequence group—corresponds to 1 program object; and
the stream identification—corresponds to 1 stream object;
wherein said position objects comprises the attribute information of 1 or several objects, and said attribute information comprises priority information, transparency information, encryption information, copyright information, client information, operation set under support, information sources and target information, addition time and effective time of position set and the attribute for introducing new objects from position set;
wherein said priority information in said object attributes is used for the cooperated operation of different position sets that when flows with different priority are simultaneously played in the same player, the stream with the highest priority is played; when program frame sequence groups with different priority are simultaneously played in the same player, the program frame sequence group with the highest priority is played; when frames with different priority are simultaneously played in the same client, the frame with the highest priority is played; that is to say, when multiple information with different priority are located in the same position at the same position set, and these information are played in the same player, only the information with the highest priority can be played;
wherein the transparency information in said object attributes is used for defining the transparency of objects corresponding to position set;
wherein the encryption information in said object attributes is used for encrypting the objects corresponding to position set, including encryption modes and key information;
wherein the copyright information in said object attributes is used for describing and protecting the copyright of the objects corresponding to position set, including the ownership information, authentication information and use information of copyright;
wherein the client information in said object attributes is used for describing the client authority of the objects corresponding to position set and utilizing the client classification information, said client authority description includes: download authority and play authority; said utilization of client classification information includes: the classified control of the content itself.
wherein the attributes for introducing new objects from position set in object attributes are used for identifying the attributes and functions of new objects introduced from position set and describing the movement conditions; said new objects include: video, flashes, pictures, images, sounds and word; wherein the attributes for introducing new objects from position set include the creation time of new object, the position parameter and movement status in position set, the duration and end time of the object, and the relation with position sets or surrounding objects.

30. The method, as recited in claim 28, wherein said capturing method of zone inside the frame of said position sets is selected from the group consisting of:
adopting the FMO mode of H.264, randomly assign macro-block to different slice groups by setting the mapping table of macro-block sequence, and take the slice group zone as the position to add information set;
adopting the VOL method of MPEG4, take the position of display zone of object stream corresponding to frames as the position to add information set; and
adopting image recognition algorithm, object tracking algorithm and algorithm of extracting foreground objects from background, or respectively identifying the object zone between frames and then adopting the interpolation method to divide various zones in video frames; the above zones are positions for adding information sets.

31. The method, as recited in claim 27, wherein a universal information set, including all of said position set, said operation set and said function set and said property of the object corresponding to said position set, is set at one of said client, server, and extending server, while the information set corresponding to the video resources received at client is described as a subset of said universal information set.

32. The method, as recited in claim 27, wherein said client determines the activation position according to the position set information of said information set and uses said position set to operate said corresponding operation set to activate said function set corresponding to said position set; wherein the corresponding functions to be executed are that:
said client determines whether the position set information of information set is in said universal position set; wherein when the position set information of information set is not in said universal position set, no operation is carried out while all operation is invalid; wherein the current operation set is acquired and the operation of the corresponding operation set is determined to be existed in said position set, wherein when said operation of the corresponding operation set is existed, the program instruction of function set corresponding to said position set and said operation set are executed, wherein when said operation of the corresponding operation set is not existed, no program instruction of function set is executed.

33. The method, as recited in claim 26, wherein the jump function, which is included in said function set, includes: jump to another frame after the operation of one frame, jump from the display zone of one frame to the designated zone of another one, jump from the display zone of one frame to another frame and jump from one frame to the designated zone of another one.

34. The method, as recited in claim 28, wherein the zoning of said zone in the video frame consists of the one of two modes of object-based zoning and free zoning.

35. A system of using information set in video resources, comprising a client and a server;
wherein said server adds information set in the video resources by one of video out-of-frame method and intra-frame addition method, and sends said information set to said client; wherein said video out-of-frame addition method consists of the description file mode of information set, service frame mode and message communication mode;
wherein said client determines the activation position as per the position set information of said information set, and uses said position set's corresponding operation set to activate the corresponding function set of said position set and operation set and execute the corresponding function; wherein at least one of said operation set and function set is set at one of said client and said server.

36. The system, as recited in claim 35, wherein said server comprises:
media import module for importing the media stream into said server;
information adding module for creating information set file and adding the information set to media file;
media storage module for storing said information set and media file; and
network module for sending information set and media stream from said server to said client;
wherein said client comprises:
network module for acquiring information set and media stream from said server;
information identity module for acquiring and identifying the content of information set, including position set, operation set and function set;
operation sensing module for acquiring the executed operation in the operation set corresponding to said position set;
function realization module for activating the corresponding function set of said position set and/or operation set and execute the corresponding function; and
media play module for playing the corresponding media information;
wherein the corresponding function of information set is realized by one of said server coordinating with one or more clients, and said client coordinating with one or more servers.

37. The system, as recited in claim 35, further comprising an extending server coordinating with said client to carry out the designated function, wherein said extending server comprises:
function realization module for coordinating with said client to carry out the designated function of said information set; and
network module for the information communication between said client and said extending server;
wherein the corresponding function of information set is realized by one of said extending server coordinating with one or more clients, and said client coordinating with one or more extending servers;
wherein, at the system level, any two of said server, said client and said extending server are merged, with their functions mutually independent, which can be realized by one of putting in one hardware and putting in one software platform;
wherein position set, operation set and function set are adapted to show up in a given function form by setting said operation set at one of said client, server, and extending server, wherein the functions are adapted to set to be realized at one of said client and extending sever with given program.

38. A method of adding service frame into video resources, comprising the steps of:
creating service frame in the video resources by a server; and
adding information set content into said service frame;
wherein said server uses said service frame to load said information set and to send it to a client, wherein each service frame is corresponding to the one or more video frames continuously or discretely organized.

39. The method, as recited in claim 38, wherein said service frame has the basic frame structure and said information set are stored in said frame structure;
wherein said information sets loaded by said service frame include: a position set, a operation set corresponding to said position set, and a function set corresponding to said position set and operation set;
wherein each position in said position set has a corresponding object, and each position object has one or more object properties; said object properties comprise: the priority information, the transparency information, the encrypted message, the copyright information, the client information, the supported operation set, the information source and/or target information, the adding time and the valid time of position set, the new object's property introduced from to the position set.

40. The method, as recited in claim 38, wherein said service frame is created at the same time of creating the video frame file, or is created after the creation of the video frame file;
wherein said service frame and video frame is adapted to be transmitted in one or more transmission paths individually in different path;
wherein said service frame and video frame is adapted to be analyzed with one or several different grammatical structures;
wherein said service frame and video frame is adapted to be stored in one file or respectively in different files;
wherein said service frame is adapted to adopt the compressed or uncompressed method for transmission.

41. A method of adding frame sequence into video resources, comprising the steps of:
choosing several adjacent or nonadjacent frames that have logical relation at a server and make said frames as an orderly set, viz. frame sequence group;
making one of the start position and end position of frame sequence group as an element of a position set; and
adding the position object property of the frame sequence group into the corresponding position set property.

42. The method, as recited in claim 41, wherein said frame sequence group is corresponding to the logically continuous video clips and said position object property of said frame sequence group includes:
the priority information, the encrypted message, the copyright information, the client information, the supported operation set, the information source and/or target information, the adding time and/or the valid time of position set;
the encrypted message in said object properties being used for the encryption of the position set's corresponding object, wherein said encrypted message comprises encrypted mode and key information;
wherein said copyright information is used for the copyright introduction and protection of the position set's corresponding object, including the copyright ownership information, the copyright authentication information and the copyright application information;
wherein said client information is used for introducing the client permission of the position set's corresponding object and applying client's classified information; wherein said introduction of client permission comprises the permission for downloading or playing; said application of the client's classified information include the classified control of content.

43. A method of adding zone object and its property into video resources, comprising the steps of:
a server executing zoning in the video resources and zoning mode comprising one of object-based zoning and free zoning; and
regarding said zone as the object, setting the corresponding property information for each object and set the corresponding information set by said server.

44. The method, as recited in 43, wherein said object zoning comprises the steps selected from the group consisting of:
marking the object zone manually, tracking automatically the object position, and marking the object's contour information; and
marking manually each individual object zone at the apart number frame, simulating the motion curve by using the interpolation method, and marking the object's contour information.

45. A method of adding priority into video resources, comprising the steps of:
adding priority information into the property information of position set in information set by a server; and
carrying out the merge operation of different positions as per said priority by a client, in condition that:
when the frames of different priority are played simultaneously at the same client, only the frame with the highest priority is played; and
when the zones with different priority are displayed in one frame, only the zone with the highest priority is displayed.

46. A method of collecting user information through executing operation on a position set object in the video frame, comprising the steps of:
acquiring a streaming media and the corresponding information set of said streaming media by a server;
executing and receiving an operation set in said information set corresponding to media for receiving by a client, and sending the information set content and client information to an extending server; and
collecting said client information from said client and said content information related to media by said extending server; wherein said client information comprises:
client's network address, and client's ID and property.

47. A method of using information set in the video frame, comprising the steps of:
acquiring the video frame required to be added to the information set by a server; and
choosing an intra-frame position to add the information set, wherein the position to be chosen comprises the head of video frame or its tail.

48. A method to add regional position profile into video resources, comprising the steps of:
partitioning said regional position into squares of same size which is calculated by pixel, including: 1×1, 2×2, 4×4, 8×8, 16×16, 32×32; wherein the situations of every line crossing through the squares are marked separately by a number;
when said squares are crossed through by regional position profile, marking two points of squares being entered and exited, and then connecting said two points by line, which is considered as part of regional position profile; and
when all said regional position profiles are marked by the line crossing through squares, finding the situation of line crossing through squares which is most close to the exist number mark, and then marking it in accordance with the predefined number for square-penetrating situations.

49. A method to set zone or regional profile for video frame based on the current video structure, comprising the steps of:
during video coding, adding a new plane based on the exist three-dimensional video data, and setting zone or regional profile in said plane; and
coding the new plane together with the current video data by a server and then sending them to a client;
wherein said setting zone in plane is one of adopting zone code and geometry parameters;
wherein the number of said plane is one or more.

50. A method to confirm position information in service layer and to control object, comprising the steps of:
receiving video information, and playing it at ordinary video playing layer; and
superimposing service layer upon the ordinary video playing layer, confirming the position information of the service layer, and controlling the new media objects at the defined position within said service layer;
wherein said positions of said new media objects are defined at one of the position set centralizing information, and the fixed position chosen by one of mouse and keyboard at client side;
wherein said operating new media objects includes local control and remote control, wherein said local control is to use one of said keyboard and mouse to control the new media objects, while said remote control is to control the new media objects by the method of information set through server;
wherein said controlling new media objects includes: creating new object, moving object, canceling object, and switching object;
wherein said new media objects include: video, cartoon, image, sounds or words.
